(19) United States
(12) Patent Application Publication
(10) Pub. No.: US 2022/0288858 A1
(43) Pub. Date: Sep. 15, 2022

(54) TRAY PACKING SYSTEM FOR ADDITIVE MANUFACTURING

(71) Applicant: Bryan C. Norman, Houston, TX (US)

(72) Inventor: Bryan C. Norman, Houston, TX (US)

(73) Assignee: Kraftwürx, Houston, TX (US)

(21) Appl. No.: 17/197,038

(22) Filed: Mar. 10, 2021

(51) Int. Cl. B29C 64/393; G06F 30/10; G06F 30/20; G06Q 30/06; B33Y 50/02; B33Y 80/00

(52) U.S. Cl. CPC B29C 64/393; G06F 30/10; G06F 30/20; G06Q 30/0621; B33Y 50/02; B33Y 80/00; G06F 2113/10

(57) ABSTRACT

Methods and systems for producing a three-dimensional object received by the system and organizing a plurality of three-dimensional objects received by the system and where data corresponding to the three-dimensional model(s) received by the system is nested and stacked by the system and compiled with other three-dimensional model data received by the system into tray files that are then transmitted to a manufacturing device for production of the object, using the data to do so, such that the object corresponds directly to the three-dimensional model.

### CROSS REFERENCE TO RELATED APPLICATIONS

The present application is a continuation application of U.S. Serial Number Ser. No. 16/134,717 Filed Sep. 18, 2018 and Ser. No. 15/893,179, filed Feb. 9, 2018, which is a continuation application of U.S. Ser. No. 13/374,062, filed Dec. 9, 2011, which claims priority to U.S. Pat. No. 8,515,826, filed Jun. 10, 2011, which claims priority to U.S. Ser. No. 11/750,499, filed May 18, 2007, which in turn claims priority to the U.S. Provisional Ser. No. 60/747,601, filed May 18, 2006. Each of the above-referenced applications is incorporated by reference herein in their entirety.

### FIELD OF THE INVENTION

The present invention relates to the design, sale, and manufacture of made-to-order or mass-customized products. More specifically to a computer-based method and system for customer-driven design, sale and manufacturing of unique or custom-made product(s) exclusively through a highly efficient sales & manufacturing system which advantageously combines key elements of computer aided design methodologies, the internet and Additive Fabrication methodologies to personalize or customize said products.

### BACKGROUND OF THE INVENTION

The customization of durable goods products is a desirable characteristic that many retail markets would enjoy being able to broadly utilize and many consumers would enjoy broadening their product selection and bringing what they buy closer to what they want. Unfortunately, sales, distribution and manufacturing systems designed to deliver mass-manufactured goods to consumers and or job-shops that do custom manufacturing are not positioned to effectively deliver mass-customization, generally placing custom-designed products out of the reach of consumers. Additionally, the machines, methods and labor are ineffective at delivering customization cost-effectively. An example is the manufacture of class rings or other jewelry. The diversity of these products is defined by the selection of molds and tooling used to inject wax which is used to cast the final product. A manufacturer cannot provide an infinite product selection or face the challenge of also producing and storing an infinite number of molds and tooling parts.

The customization characteristics desired by individuals are diverse and therefore, the method is applicable to a wide array of products. For example; a customer may desire a custom-designed broach or ring that contains a 3D representation of a family crest or insignia. To obtain this custom product requires specialized training including 3D CAD modeling and design experience or at the very least CNC programming experience. Other customizable products might include custom valve covers for a hotrod. Designing these products and having them manufactured by CNC machining would be expensive and, the equipment necessary is not normally available to the public nor are the operating procedures of the equipment. Therefore; customization options for consumers are often limited and access to customization of products is difficult. The result is that individual needs and or desires are not always met, and customers therefore settle for less than what they wanted or desired.

Computer-based networks, access systems, websites, databases, processing speeds and 3D geometry manipulation have reached a sufficient level of performance to provide consumers with the ability to drive changes to products themselves in many aspects. Consumer capabilities to understand such systems have also reached a level sufficient for consumers to realistically be involved in at least some aspects of a design process, for example those that do not cause risk to a customer or liability to a manufacturer as defined by constraints preventing a customer from violating the constraints during design for personalization or customization.

Computer-based 3D design & design implementation systems are based on point-of-use deployment models. Such systems are also intended for use by someone skilled in the art of CAD/CAM and design methodologies. This effectively means that manipulation of the geospatial/3D geometries commonly called CAD models requires advanced knowledge and significant time to develop. When properties such as structural integrity or thermal properties are involved, even basic design skills for 3D move out of the realm of consumers with basic skills in this area, often to an advanced engineer-level which is beyond the comprehension of the general public. CAD systems are also precise and unforgiving in many aspects of their use. Some examples of 3D design tools include Autodesk Inventor, Solidworks, Unigraphics, CATIA, Mechanical Desktop, MAY A, Rhino 3D, 3D Studio Max and more.

Computer-based 3D design and design implementation systems are required to produce a product by additive fabrication methods. Such systems are costly and must be purchased by a user and added to the user's computer. The user must also learn how to use the system, the engineering behind designing a product and finally, locate a facility to produce the product. Also, designing a product from scratch is time consuming, even for someone skilled in the art of CAD/CAM design, engineering, and manufacturing.

Rapid Prototyping and Additive Freeform Fabrication are used interchangeably to describe technologies that have been developed to create or “manifest” 3D objects representative of computer-based geospatial/3D geometry through the process of depositing materials in an additive or layered process, resulting in a net or near-net shaped product conforming to the dimensions of the 3D computer-based geometry upon which such an object is based without tooling or molds or much of the labor required in traditional subtractive methods of manufacture. At present there are approximately 25 additive fabrication processes covered by various patents. Each technology has inherent limitations and benefits including the feature resolution, materials that the technology can use, speed, surface finish and a plethora of other parameters by which a part can be measured however; the deployment model of such technology is, for the most part, considered for prototyping and not for direct digital manufacturing. For example; a wax polymer is ideal for the manufacture, by lost wax investment casting, of custom jewelry. Solid-Scape additive fabrication technology is ideally suited for the manufacture of jewelry. Solid-Scape hardware is capable of printing or manifesting, at high resolution in a relatively small build envelope. Other technologies, such as Selective Laser Sintering from EQS are suited for the manufacture of larger components made from nylon materials or a limited selection of metals however the surface finish of the SLS process is considered rough when compared to other processes.

Current deployment methodologies in use for both CAD/CAM systems and additive fabrication technologies limit the widespread use of the technologies. For example, manufacturing more than a small lot of products on any given machine in a reasonable timeframe is thwarted by throughput. However, if machines in one location were linked to machines in multiple distributed locations, the effective capacity would be greatly increased. The net result of these differences is that all of the various additive fabrication processes may be required to provide the net result of a finished product consistent with expectations for a particular product.

Since it is prohibitive for any one facility to own every machine of every type from every manufacturer, it is advantageous to link many facilities together, further realizing the full potential of additive fabrications.

Computer-based implementations of Product Lifecycle Management (PLM), Product Data Management (PDM), Master Production Scheduling, part routing and part nesting systems are capable of intelligent and automated actions to manage decisions for operations in a production capacity and planning system and can include other intelligent decision-making abilities such as procurement and inventory management but they are designed to move “real” products, not virtual products through the system.

It is therefore beneficial to effectively combine additive fabrication, Computer Aided Design methods, capacity planning and the Internet with automated PDM!PLM production scheduling and routing systems in a manner that enable deployment of additive fabrication methods and technologies as an Enterprise Resource Planning (ERP) production system. As such, embodiments of the present invention advantageously create a disruptively competitive and efficient system for the design, sale, and manufacture of individualized or customized products by synergistically combining facets of many technologies into a more productive method and tool.

### SUMMARY OF THE INVENTION

In light of the preceding background, embodiments of the present invention provide methods and systems for user/customer selection, design, sale and manufacture of customized/personalized products through a streamlined and/or automated or semi-automated process combining computers, the internet, 3D modeling (also called CAD modeling), a customization interface including an interactive controls suite connected to the 3D modeling system for the purpose of allowing a user/customer to personalize or customize a product represented by a 3D geometry or multiple 3D geometries, whereby the user/customer is connected to the Cad modeling system through a website or web portal along with a 3D viewer connected to the 3D CAD geometry manipulation system for the purpose of providing design feedback and pre-purchase visualization to said user/customer accessing the system through said website or web portal, whereby said product is manifested in an automated or semi-automated fashion via additive fabrication methodologies. Embodiments of the present invention improve operational performance in a design, sale and manufacturing system to design, manufacture and sell a wide variety of products which can be adequately defined by one or more computer-based design and design implementation methods to 3D geometry manipulation where said geometry can be properly manifested by any additive fabrication technique.

According to one embodiment of the present invention, the method is carried out by a computer-based system which includes at a minimum; a computer, a software-based geospatial/3D modeling engine (a CAD engine), input/output controls to the 3D modeling engine, a 3D viewer engine, a database or file system and a production routing and scheduling system interconnected with additive fabrication hardware.

Embodiments of the invention are designed to interface a customer directly with the digital representation of their intended physical manifestation, thereafter, referred to as a product. In essence, the customer is peering through an internet “portal” at the customer's unique product and can interact with it during the design process. Any changes made by the user of the system that occur to the product become unique facets of the product the user/customer is building or creating for purchase. Embodiments of the system are capable of interfacing with a plurality of customers simultaneously and are designed to do so.

Another embodiment of the invention can automate most, and in some cases all, of the post-sale production operation, thereby removing most, if not all, of the human factor requirements from the system and thereby removing or minimizing the number of people involved within production environment, further optimizing the manufacturing process, maximizing productivity and minimizing labor needs.

Advantageously, embodiments of the system are conceived to be capable of assembling and modifying 3D components of a customer's unique product in increments measured in milliseconds while the product exists as a mathematically derived 3D model or models. This is many orders of magnitude faster than any other known production system available today.

Embodiments of the method and system can utilize additive fabrication for manifestation of a unique product or component(s) of a product, thereby making the systems' inventory highly flexible. Embodiments of the system are designed to use the full gamut of available Additive Freeform Fabrication technologies collectively making possible production of products with diverse materials. Since embodiments methods and systems are developed around the concept of 3D geometry and CAD modeling, the methods described herein can include future Additive Freeform Fabrication technologies as the intended output technique inasmuch as the additive fabrication technique relies on 3D data as the basis for output through the additive methodology.

Furthermore, embodiments of the present system provide a completely flexible and scalable production operation. Deployment models may include an “in-house” model where all additive fabrication hardware resides in a single facility or at multiple facilities including diverse and/or divergent locations. Capacity within a locally deployed system can be expanded by purchasing additional Additive Freeform Fabrication hardware and adding it to the system or by taking advantage of distributed networking, the internet and available additive fabrication hardware available at other facilities. These facilities may include bureaus or other manufacturers using one or more embodiments of the present system(s).

Furthermore, embodiments of the present invention may make use of multiple types of additive fabrication hardware simultaneously or concurrently to manifest a plurality of components of an assembly for a product that is, by design or by desire, necessary to be made of different materials and assembled from the various components. The system in this situation would be responsible for routing components that must be manifested out of differing materials to several or many local or remote locations for fabrication via additive fabrication processes that support fabrication of the desired or required material substance. Examples of this material might include metals of varying natures, plastics or polymers of varying nature, waxes or even composites or slurries. Such varying needs can require use of the entire gamut of Additive Freeform Fabrication hardware.

In another embodiment, the method and system can be accessed by a user/customer via one or more communication methods whereby the user/customer accesses the system over the communication network, the method providing the user a plurality of product selections to said user/customer back through the communication method, receiving from said user/customer via the communication method a selection of a product or products, and providing said user a customization/personalization interface, the customization/personalization interface providing at least one personalization/customization tool or option to said user/customer to create an individually customized product and whereby said customization/personalization option does not violate any parameter prevention its manifestation through Additive Fabrication methodologies.

Wherein the summary of the invention provided, including certain aspects, advantages and novelty of the invention have been described herein. It is thoroughly understood to one skilled in the art, that not necessarily all such advantages may be achieved in accordance with any embodiment of the invention. Thus; the invention may potentially be carried out in one or more manners that optimize one or more advantages as described herein without achieving other advantages as descried herein.

These and other embodiments of the present invention shall become apparent to anyone skilled in the art who review the detailed description of the embodiments herein including but not limited to figures, features, or other descriptions disclosed.

### DESCRIPTION OF RELATED ART

Software applications for CAD modeling exemplified by those from Solidworks Corporation and Autodesk, Inc., include tools designed to provide for mechanical deformation and or mechanical assembly of a plurality of individual 3D parts to create an “assembly” where each discrete component is represented in the assembly as a 3D model and therefore the assembly is also a 3D model. The purpose of said software is mechanical design and design validation. Said software was intended to be utilized for the purpose of design and design validation by a designer or more specifically a design engineer who is someone that understands the intricacies of mechanical fit and function.

Manipulating a single file that is part of an assembly in Solidworks, Inventor and other mechanical design software can impact an assembly of parts and therefore the assembly will also reflect the modifications including feedback on collisions of parts and an inability for the combination to exist physically. Solidworks U.S. Pat. No. 6,308,144 encompasses some of the concepts of moving and or repositioning objects in an electronic manner representative of mechanical assembly of physical products. Autodesk also has a similar assembly method within their software that electronically “bonds” 3D objects in the computer in a manner like Solidworks. Such is the nature of mechanical design software, to validate and help drive accurate and meaningful reduction in design cycle times by allowing an engineer to design the product virtually. Without this assembly methodology, the design and analysis would not be possible.

All 3D design and modeling software is built on a commercially available 3D CAD engine. The most popular 3D CAD engine today is made by Parasolid and embodied in U.S. Pat. No. 6,489,957; “Three-dimensional geometric modeling system with multiple concurrent geometric engines”. Other 3D CAD engines exist such as an older system called ASIS. Other CAD systems exist. Most products including Parasolid are available commercially for purchase and licensing, just as they are to Solidworks.

3D viewer technology exists in a plethora of formats including the most popular format, Open GL. 3D viewers exist and render 3D geometries represented by mathematics on a computer screen, often seen at CAD workstations, in video games or other graphics applications for the purpose of providing the design engineer or artist the ability to see feedback of a 3D model on their design choices iteratively. 3D rendering and viewer engines are also used on the internet to provide, interactive catalogues of 3D models that a user can download and then use in their own designs or modify mechanically via software including Solidworks. These systems are used to provide only CAD models that are used by design engineers.

Solidworks 3D parts Stream is an interactive catalogue. It is a supplemental application of the Solidworks product which utilizes API-calls to the Solidworks software application to cause the software to manipulate geometry and deliver the results through a visualization system of products through a networked or internet-based system. The intended use of this system is to create 3D models that can then be downloaded and embedded in 3D designs during product design and validation processes as a time-saving tool. Furthermore, the 3D parts Stream product relies on the Solidworks software which in and of itself has limited or rigid functionality such as a very rudimentary ability to manipulate textual information. Furthermore; the output of the Solidworks application terminates as a 3D model which can then be embedded into a product development design. The product and process is intended as a time-saving apparatus for product design and validation. This is analogous to providing a way so that the design engineer does not have to re-draw a washer or castor or screw or some other part every time they need such a part for a new product they are designing. Solidworks brochure for the product states; “A 3D-powered catalog that allows components to be quickly downloaded and “designed in” offers greater convenience for the product designer.” Thus, is the scope of the 3D parts Stream intended use.

Rapid Prototyping or Additive Freeform Fabrication hardware of many types exist and are used today to provide prototype and limited-production output of 3D models to be used in visualization and low-cost, high-accuracy sample production during the design process, hence the name Rapid Prototyping. To date, some companies are also utilizing Rapid Prototyping or Additive Freeform Fabrication hardware for limited production of products intended for functional end use directly from, or with minimal post processing, directly from the product manifestation via Additive Freeform Fabrication.

Available CAD systems for purchase today are either mechanical design in nature or artistic in nature. Both systems have their merits and both systems have their drawbacks. Mechanical systems lack many of the aesthetic or Industrial Design elements of product design and manipulation software. Industrial Design or artistic software lacks the exacting controls necessary to define a mechanical system. Neither system is developed nor intended to be accessed and driven by a typical consumer wherein the consumer is one not skilled in the art of 3D design. The limitations of mechanical design systems extend to text information, fonts, complex or ergonomic or aesthetically please design elements.

Furthermore the systems and methods described as prior art above are not known to be combined in any manner or similar nature for the purpose or spirit of use as a complete manufacturing enterprise system in any resemblance of the method described herein, a Made-To-Order Digital Manufacturing Enterprise System which; combines one or more computer based design or design implementation methods (CAD/CAM) systems, the internet, websites, or web portals, e-commerce systems, Product Data management, product lifecycle management, master production scheduling, routing & nesting systems into a consolidated system designed exclusively for customer-driven design or design modification to geospatial/3D files which represent the final product.

U.S. Pat. No. 7,216,092 Weber, Et Al embodies a patent related to mass-customization of products in a vague similarity as the patent embodied herein however; the primary differentiator is that U.S. Pat. No. 7,216,092 is obviously, to one skilled in the art, intended for 2-dimensional printed merchandise and not geospatial/3D products. Furthermore, U.S. Pat. No. 7,216,092 embodies at least some techniques and concepts already in practice, for example, www.vistaprint.com has been using a website-based user/customer driven design system for approximately 7 years in customer-driven design and manufacture of custom printed business cards and stationary including; a database for storing and retrieving designs created by a customer through the system. Furthermore; U.S. Pat. No. 7,216,092 discloses a purpose for design by an individual and not a collaborative group.

There is no known prior art combining the methods and systems described herein including; geospatial/3D CAD/CAM data, presented to a user/customer, whereby the actual geospatial/3D geometry presented to the customer is used for purchase intent, including modification or customization for the purpose of modifying to suit individual tastes or preferences is done so through the website or web portal with the intent is purchase by the user who is considered to also be a user/customer and the product is produced in an automated or semi-automated production method including scheduling, routing and automation or semi-automatic manifestation of said part or assembly via Additive Freeform Fabrication where the output of the Additive Fabrication process or processes is considered the final product or where parts together, produced by Additive Fabrication methods collectively comprise a product for purchase through such a system.

Finally, there is no know practiced application of said method or system registered or in use through the internet by consumers which shows prior art as described herein.

### BRIEF DESCRIPTION OF THE DRAWINGS

Having thus described the invention in general terms, reference will now be made to the accompanying drawings by example where the drawings are intended to illustrate and not limit the invention wherein;

FIG. 1 illustrates a personal computer or workstation [100] utilized by a CAD Designer or engineer to create a CAD Model, using a CAD Design software package of the types available from many commercial providers [101]. The Base 3D CAD Model is uploaded to the system of the present invention. The system deploying the method of the present invention, shall allow for the input of any geospatial/3D geometry design produced in a plurality of design software tools including but not limited to Solidworks, Inventor, Rhino, Strata-Studio Pro, Maya, CATIA, PRO-E, Alias Wave Front, Alias Sketch, Lightwave 3D, DesignCAD, Enovia Amapi, Carrera 4, Hexagon, Shade 3D, Poser 6, Axel Core, Recon 3D, Anatomica 3D, Adobe Dimensions, DeICAM, Form-Z, Mechanical Desktop, Pilot 3D, Solidthinking, Unigraphics, TouchCAD, as well as Solidworks, Inventor, Rhino, Strata-Studio Pro, Maya, CATIA, PRO-E, Alias Wave Front, Alias Sketch, Lightwave 3D, DesignCAD, Enovia Amapi, Carrera 4, Hexagon, Shade 3D, Poser 6, Axel Core, Recon 3D, Anatomica 3D, Adobe Dimensions, DeICAM, Form-Z, Mechanical Desktop, Pilot 3D, Solidthinking, Unigraphics, TouchCAD an online tools such as OnShape.

FIG. 2 illustrates an embodiment of the Co-Design configuration interface for defining and configuring Co-Design features or constraints. The interface enables the first commercial user the ability to define constraint features, parameters, specifications, and values [102] that are referenced as CAD Kernel functions within the system to alter the geometry of the base 3D CAD Model during a Co-Design session, as well as to input a description of the Constraint features and a description of the product [103]. The interface and its functionality additionally enable a user to define regions and zones for each defined constraint to be applied on the base 3D CAD Model [104] and provides advanced constraint definition tools [105] or any geometric modifier possible by CAD Kernels. When the Save button [106] is pressed, the system stores the configured parameters for the current constraint, the current constraint becomes a modification “feature” having a name, and associated values related to the 3D CAD Model in the system [107]. The Co-Design interface additionally provides the ability to test the configured constraint features as a co-designer or consumer user would see the product in a browser session [108]. The commercial user may then “publish” the base 3D CAD model having one or more constraints as a co-designed 3D CAD Model having the Co-Design features associated with by publishing the 3D CAD Model as a product in the Web Shopping cart system [109] or course, the commercial user may also publish the 3D CAD Model without defining any constraints or the consumer user may opt not to configure any of the defined constraints and purchase the design as-is.

FIG. 3 illustrates an embodiment of a web page commonly referred to a product fly page in e-commerce parlance. The web page reflects an electronic shopping cart system adapted to enable the Co-Design method within the cart interface. The web page showcases a product that is represented by one or more 3D CAD Models [110]. The Interface provides a viewing option prepared by the system and caused to be displayed on the user device by the system [110] within the ecommerce page where previously configured constraint features are displayed graphically to the user as options for altering the geometry of the base 3D CAD Model [111] according to the constrain definitions previously defined by the seller and where the constraint features defined are associated with graphical elements relating to defined geometric modifiers available from the 3D CAD Kernel(s) associated with the system. The user intending to acquire the product, may alter the design by interacting with the interface which in turn occurs by the user selecting visible functional icons that case the system to apply functions that alter the base 3D CAD model utilizing computer instructions present in the modular controllers of the system. The user may see not only the 3D view of the CAD Model but also see a rendering of the 3D CAD Model [112] also prepared by the system. When satisfied, the user having Co-Designed the 3D CAD Model representing the product may request to obtain the product represented by the 3D CAD Model as well as other functionality [113] [114].

FIG. 4 illustrates the computing operations performed by the modular e-commerce website system controller [183] portion of the invention illustrated in FIG. 5. The modular system generates and causes to be displayed, at least portions of a website or web page on the users/customer device and may include a browse and search function for searching the catalog of products [114]. The system receives a selection of the product through the system-provided interface [115] and the modular system prepares and causes to be displayed on the user device, the consumer customization interface demonstrated in FIG. 3 [116]. The system processes commands for applying the geometric alterations to the base 3D CAD Model [117] and the user is iteratively provided an updated view of the alterations caused to be performed by the user which are processed by the system [118]. The system accepts a request to place the order to obtain the product [119]. Of course, e-commerce systems also accept other information such as payment types, shipping location information, quantity and other common information needed for processing an order. As denoted by the illustration, the system may provide the functionality by API.

FIG. 5 illustrates processing steps performed by the modular input/output or input/output system [157] for coordinating system commands between a user/customer and other modular controllers contained within the system. The “input/output” control system demonstrates certain commands performed by or functions of the input/output control system. The system processes requests to obtain a product represented by the 3D CAD model [120] and processes the actual 3D CAD model data files, processes catalog browse requests [121] and product selection requests in order to then display the product in the flypage and initiates the user interface [122]. The modular controller also processes requests for the base 3D CAD model for a user session for presentation in the web interface [124] and causes the system to process 3D CAD Model geometry alteration requests [125] through a 3D CAD Kernel or “engine” which is also a modular controller within the system. Throughout the Co-Design process, the input/output system iteratively processes subsequent Co-Design modifications to the base 3D CAD model through the 3D CAD Kernel as requested, depending on the selected function [126]. Finally, the input/output system provides an execution command that initiates a process for manufacturing command [127] that causes additional system steps to be performed. The input/output system modular controller initiates a set of subroutines to produce a physical copy of the 3D object by Additive Manufacturing, triggering processing steps that are novel to the Co-Design systems and methods. Of course, this module is capable of being run on any computer and by independent commercial users running e-commerce systems arranged to perform the e-commerce operation in the manner described that is particularly useful for Additive Manufacturing.

FIG. 6 illustrates processing steps performed by the modular 3D-Viewer controller system [158] which provides functions that includes establishing a design session for each user of the system when accessing a web page [128], and receiving requests from a modular I/O controller system to process a base 3D CAD model in a manner that creates a web-compatible version of the base 3D CAD Model [129] and causes a web-compatible view of the 3D CAD Model to be displayed on the user device [130] and iteratively causes additional web compatible views of the 3D CAD model to be displayed on the user device as needed during a Co-design session in a web page. Of course, as demonstrated, the displayed 3D CAD model may take the form of a 3D representation of the CAD model from the system or a system generated pixel-based rendering of the 3D CAD Model by methods such as Raytracing, radiosity, Phong shading or Gourad shading or other methods.

FIG. 7 illustrates processing functions performed by the modular database [162] system, including; retrieving 3D CAD models from the database or file system [132] and receiving requests from a system to parse 3D CAD models through a 3D CAD Kernel [133] for varying functions as well as delivering 3D CAD models to other modular controllers [134] such as the web viewer module which may request a 3D CAD model from the database and or file system based on a co-design session initiated in a website. The dataset and or file system and associated controllers may also store temporary 3D CAD model data in a database or file system for each unique customer [135] as well as fetch additional 3D CAD models for a user during a design session [136] or for processing by other processing controllers and modules [137], receive and store temporary 3D CAD Models [138], storing “meta-Data” parameters necessary for print processes [139], storing nested tray files for production [140], storing 3d printer printing device parameters and capabilities [141] and storing remote or geospatially located 3D printer device capabilities [142] such as those available from a remote product facility.

FIG. 8 illustrates processing steps performed by the system as requested and processed using the 3D Kernel or engine system [159] including; requesting that a 3D CAD Model be retrieved and “parsed” by the Kernel, meaning it is processed to accomplish a geometry change according to a selected function [143]. retrieved 3D CAD Models from a database or file system [144], performing a mate function [145] which is essentially joining two or more 3D geometries virtually or rather merging data of two 3D objects in a manner that defines their relative position to one another, an output command to store 3D CAD models in a buffer or file system or database [146] transferring 3D CAD model data to a web-viewer module for further processing in order to parse and prepare an iterative updated web compatible view of a 3D CAD model during a Co-Design Session [147] and process iterative requests for such tasks [148] including unique customer sessions in a co-design system [149], iteratively updating the web view after each processed function is performed [150], processing traveler geometry functions [151] using the 3D Kernel to generate the 3D Geometry containing the traveler information defined in the traveler feature, [152], providing 3D CAD Model analysis comprising parsing 3D CAD model data file and processing it, using the 3D CAD Kernel or engine to determine the models physical performance based on material selections [153] and enabling the configuration of co-design constraints by a commercial user within a browser session that define Co-Design features against a base 3D CAD models uploaded to the system [154].

FIG. 9 illustrates the modular nature of the overall Made-To-Order Digital Manufacturing Enterprise system comprised of containerized or modular controllers. Each controller comprised of software arranged for performing computing steps on general computing hardware and arranged to provide an array of processing functions in a manner particularly useful for Additive Manufacturing. It is additionally illustrated that the system is interconnected between the modular controllers exemplifying that the system controllers are designed and arranged to provide input and output of data by and between the modular controllers regardless of physical computing location. In particular, attention is drawn to the Application Programming Interface (API) [182] module which, according to commonly understood computing practices provides methods to enable the various modular controllers to be able to communicate between each other and for 3rd party users to integrate and control the system. The figure generally divides the made-to-order portions, on the left side of the figure, from the Digital Manufacturing Enterprise system or Digital MES portion of the invention on the right side. Each containerized application working in and arranged to function in conjunction with other modular controllers. The arrangement and use of the various portions of the invention may therefore be used or not used by the commercial user of the system and likewise by a 3rd party user using the system.

FIG. 10 illustrates, 3D CAD Models described in computer files and representing “products” stored in a database [184] or file system. Examples of the products include a spaceship top [185], a heart-shaped pendant or charm [186], an anniversary ring [187], a message band [188], an airplane model [189] and a football charm [190]. Of course, the database or file system can also be a PDM/PLM system as employed by Commercial Enterprises. Revision controlled documents are available from PDM/PLM systems.

FIG. 11 illustrates an exemplary configuration of a deployment model of the invention comprising; a group of server devices providing database functionality for bulk storage and retrieval operations of the operation of the system [191], the e-commerce system operating on a separate computer server [192], Search functions [193] operated on a separate computing device, a 3D Printing print server [194] operated on a separate computing device, a file server [195] operated on a separate computing device and storing 3D CAD models, the Co-Design system operated on a separate computing device, a 3D file buffer for temporary storage and retrieval of 3D CAD model data [197], a web server [198] enabling a plurality of users simultaneous access to the operations of the system over a communication network [199] where the computer servers, utilizing the modular controller software performs the invention. The physical location of each server is not relevant to the functionality of the system. The figure also illustrates the opportunity for portions of the system to be divided amongst commercial users.

FIG. 12 illustrates access to the invention by users utilizing a home PC [200], a notebook computer [201], a mobile cellular device [203] which communicates through a communication network [210] enabled by a the web server [212] to provide system functionality demonstrated within the dashed line of an array of computer servers performing the functions of the invention utilizing the software and general computing hardware. The figure additionally illustrates a distributed manufacturing server device [213] enabling communication with geospatially located additive manufacturing facilities. Each remote manufacturing facility having at least one computing device [204] and each remote facility [205] having Additive Manufacturing device(s) [206] for production of products from 3D CAD Model build files transmitted to the remote facilities and received from the system [211] over a communication network. The remote facilities accessing the Digital MES portions of the system over the communication network, using the computing device at each facility or bureau. The figure additionally illustrates Additive Manufacturing devices located locally and available for production of parts by additive manufacturing from build files prepared by the system. For example, these machines might include a wax printer [207], a DMLS printer [208] or a plastic printer [209]. The system functionality is illustrated herein to enable distributed manufacturing. Distributed Manufacturing denotes that each of the remote computing devices is also using the Digital MES portion of the invention at their location for aggregating, organizing, arranging, scheduling, and packing tray files for production on local printer devices.

FIG. 13 illustrates an abbreviated or simplified representation of the operational model of the invention. A CAD designer creates a base 3D CAD Model [213] and uploads it to the system. The system is configured to receive and store the model as a product and to present an online catalog of such 3D CAD Models to consumers on a web page in an e-commerce fashion. The consumer is able to make a selection of a product represented by one or more 3D CAD Models from a catalog of 3D CAD models presented on the web page and may receive and have displayed on the users computing device, an interface [216] that includes the Co-Design interface. The invention is exemplified as a computing system [217] handling the computerized operations and workflow management of the invention and arranged to transfer build files generated by the system to a 3D Printer device [215] for output. In this figure, a Solid-Scape wax casting pattern for Lost Wax Investment Casting.

FIG. 14 illustrates an exemplary embodiment of a commercial use case of the invention for design, sale and manufacture of custom Class rings including; the design of 3D CAD Models [218] designed in any 3D CAD Modeling package and comprising a core of a ring [221], a bezel or crowns [222] containing a co-design text feature configurable by a consumer user, a gemstone [223], a combined gemstone and crown [224], a core with a casting sprue [225], shank art panels [220], a core having a shank suppressed [226] in a web view, a complete 3D CD Model representing a class ring [227] and an array of 3D CAD models held within a database [228] and representing optional configurations available for the class ring and an interface [219] for the selection, Co-Design and purchase of the product—represented by 3D CAD Models within the system. The figure also illustrates how the component CAD models are assembled and exchanged [221] using the shanks [228] and shows the sprue [226] that is hidden during the consumer session [219] using the retail interface [218] that is generated as geometry containing a digital traveler feature [225] and a final product [227] comprising a ring with a real gemstone that is not printed.

FIG. 15 illustrates a general concept for a class ring comprised of multiple interchangeable 3D CAD model parts. Each part mated to the core [232] by a part mate function controller [175] and representing a left-hand shank showing a 2 on the panel, a bezel [230] showing a 3 on the panel, a right-hand shank [231] showing a 1 on the panel. Each panel interchangeable by computer function within the system performing the Made-To-Order portion of the invention.

FIG. 16 illustrates a configured co-design constraint feature for text. The text feature [234] is configured in the Co-Design interface as a feature to the base 3D CAD model, which is in this case, a class ring bezel [233]. The constraint is defined in the co-design interface illustrated in FIG. 2.

FIG. 17 illustrates a gemstone which is common in jewelry. The inclusion of the 3D model of gemstones within the system is a necessary feature because otherwise the ring products would appear odd to the users in an e-commerce environment and therefore included for visual representation only because gemstones are in many cases natural made and not 3D printed.

FIG. 18 illustrates a gemstone [235] 3D CAD model mated by a part mate controller [⊆] to a 3D CAD model of a bezel [236] and having a configurable text feature co-design constraint function as an extrusion in 3D [237] performed by an extrude module [172] and font module [174] and generated by the 3D Kernel or engine [159].

FIG. 19 illustrates a novel commercial business model utilizing the system for on-demand manufacturing by additive manufacturing of class rings or other custom jewelry including consumers shopping online [238] via website enabled by the invention and served to the consumers by the method and system [239] which is used to generate Co-Designed 3D CAD Models and prepare them for production by 3D Printing. In the case of jewelry, 3D printing [240], in this example, produces a wax pattern [241] which is used for lost-wax investment casting [242] and then prepared and packaged for shipping to the customer [243] by customary delivery methods [244]. The business model is applicable to many other market verticals,

FIG. 20 demonstrates system processing steps performed by the modular production system controller or “production system”. The system is programmed to use general computing hardware to perform the processing steps. The orders are represented by a 3D CAD Model and meta-data describing the production criteria for the 3D geometry. The processing steps include; receiving orders for production queuing [245], analyzing the production needs for the 3D CAD model [246], determining an organization production plan for the 3D CAD models locally [247] and remotely [248], determining quality ratings of remote production facilities [249] and using the quality data to make a determination to use a remote facility indexed in the system [250], selecting a 3D printer device indexed within the system locally or remotely [251], routing orders through additional processing steps through the system based on the analysis performed an organization production plan determined by the system [252] the order for production according to production scheduling techniques [252] and generating and providing an estimated delivery time based on estimated production lead time [253]. The controller additionally enables commercial users to input production equipment information including quantity, type, materials [014] and other criteria utilized by the system for organizing, arranging, scheduling, and routing 3D CAD Models through the system [254]. The figure also illustrates the production system including a Product Data Management System, Product Lifecycle Management System and ERP functionality along with the Additive Manufacturing Production System functionality.

FIG. 21 demonstrates system processing steps performed by the nesting system modular controller [162] which performs system processing steps of; parsing and analyzing 3D CAD model geometry within 3D CAD model files for orientation, determining the optimum build angle to minimize build time for the model based on the analysis [256], re-orienting the 3D CAD model geometry for nesting and staking operations based on the determination [257], processing in conjunction with the stacking system modular controller [258] shown in FIG. 22 and accepting commercial user input for parameters for the nesting system operations [259].

FIG. 22 demonstrates system processing steps performed by the stacking system modular controller [161] which performs system processing steps of; receiving re-oriented 3D CAD model file geometry for production [260] from the nesting system [258], electronically and virtually adding the 3D CAD Models processed to an arrangement of 3D CAD model files [261] based on a build envelope or printable area defined in the system [262] or reaching a preset limit and writing a completed nested arrangement of a batch or group or subset group of 3D CAD models to a “tray” file [265] which is a nested arrangement of the batch or group of individual 3D CD model files combined in a single computer file called a tray file and representing a build file of packed 3D CAD Models fitting with the bounding box of used to control, at least in part, an additive manufacturing device to produce the geometry within the tray file. The figure also reflects the preparation of arrangements of 3D CAD model file geometry fitting with the printable area or bounding box of a 3D Printer device based on parameters defining the printable area or bounding box of an Additive Manufacturing device and processing steps of the nesting system [162] and stacking system [261] for a 3D printer device.

FIG. 23 illustrates the output of the system processing steps jointly performed by the stacking system modular controller [161] and nesting system modular controller [162]. The figure reflects a nested and batched arrangement of 3D CAD model file geometry [266] fitting with the printable area or bounding box of a 3D Printer device [267] based on parameters defining the printable area or bounding box of an Additive Manufacturing device having an indexed profile in the system by a commercial user [254] and processing steps of the nesting system [162] demonstrated in FIG. 21 and stacking system [161] ] demonstrated in FIG. 22 and representing an arrangement of 3D CAD Models for production by a printer device as illustrated in FIG. 36.

FIG. 24 illustrates a class ring core [268] and an appendage [269] commonly known to one known in the casting manufacturing industry as a sprue. A sprue is used as a flow path for molten metal in the lost-wax investment casting process. The sprue in this case provides two benefits, a casting sprue function, and a digital traveler feature function. The Traveler feature function is black or dark solid colored to reflect its function and that it may be suppressed from view in the web browser during a Co-Design Session. It is suppressed because seeing this geometry feature would be confusing to a retail user. The Sprue is 3D printed however, meaning the geometry is not suppressed in later stage system processing.

FIG. 25 illustrates the class ring core [270] and the sprue appendage [271]. The sprue has numerical values which are also 3D geometry generated on the sprue geometry [272] which were generated by the digital traveler system modular controller [163] processing steps. In this figure, the digital traveler geometry would be output by a 3D printer device enabling the easy identification of an individual order within a larger array of individual orders [266] output by the system. The Digital Traveler geometry is an update to the base 3D CAD model performed by the system in a manner that may occur before nesting and stacking operations such that the geometry is included in the analysis of the nesting and stacking operation resulting in nested batches of 3D CAD models.

FIG. 26 illustrates several versions of digital traveler geometry, methods and locations including; the class ring sprue geometry [273], an appendage [274] or direct part marking [275]. The Digital Traveler geometry in each case enabling part tracking and identification information to be generated dynamically by the system modular controllers during system workflow performed to prepare production.

FIG. 27 illustrates an exemplary production scheduling interface of the invention. Each Additive Manufacturing device [276] indexed within and representing a production resource available to the system is presented, along with its production schedule. Each additional machine in the production resource list is also reflected in the system such as machine 6[279]. Each black bar represents a production scheduled bath job of 3D CAD models prepared and arranged for production by the system in a nesting operation, in a sequence of jobs and assigned to each Additive Manufacturing device [277]. Each job bar represents a “tray” file of properly nested or “packed” arrangements of 3D CAD Models. The chart or graph [278] represents production utilization statistics for each machine such as machine number 1 [276] which is shown selected to present the statistics for the particular AM machine selected. The production system including production scheduling adapted to perform in a manner particularly useful for additive manufacturing.

FIG. 28 illustrates system processing steps performed by the modular traveler controller system or Digital Traveler controller and performing processing steps for; receiving a production request for processing a 3D CAD Model during a production subroutine routing [280], parsing production criteria required to be converted to geometry related to the unique order [281], submitting a request from the controller to a 3D CAD Engine to generate the data as geometry [282], waiting for the 3D Kernel or engine to generate the geometry [283] and update the 3D CAD Model file with the geometry and routing the production command to the next processing step in the production subroutine [284]. The modular controller also provides an enables traveler definition as geometry to be defined in an interface including traveler geometry, location relative to the 3D CAD Model and what information to be converted to geometry [285].

FIG. 29 illustrates system processing steps performed by the modular material matching controller including; receiving processing requests from the production controller to analyze the design intent of a 3D CAD model and its corresponding production criteria information [286], parsing the database of indexed production resources for 3D printer devices meeting the production criteria [287], sending the 3D printer device information for 3D printer devices meeting the production criteria to the system production scheduling controller [288] and storing information in the database for recall [289]. The modular controller also having and providing a commercial user with an interface to define material criteria, in a manner, associating it with 3D printer devices indexed within the system and therefore design intent [290]. For example; a Wax Solid-Scape 3D printer device may be associated with a material selection by a consumer user selecting gold or sterling silver where the wax is needed to cast the gold or silver.

FIG. 30 illustrates system processing steps performed by the modular remote manufacturing controller including; analyzing remote manufacturing facilities and capacity indexed within the system for capabilities to produce the 3D CAD Model remotely [291] and providing the analysis information to the production scheduling system controller [292], sending requests to the quality rating system subroutine modular controller to compare past production event quality to database characterization for the remote facility selected [293] and storing information in the database for recall by the system. The remote manufacturing controller module also provides an interface for external production facilities to create a profile within the system and to input facility production capabilities, equipment, materials, and quantities of equipment [295]. The production capabilities of the remote facilities input by remote commercial user manufacturers being made available to the systems production scheduling controller for production scheduling activities performed by the system. and 19 depict network diagrams of embodiments of the present system.

FIG. 31 illustrates system processing steps performed by the modular quality rating controller including; receiving inquiry requests from the production scheduling controller for quality information [296] where the quality rating information is comprised of characterized ratings based on past production jobs, analyzing the past quality information for reputation data based on remote factories connected to the system [297] and making the resulting information available to the production scheduling system [298] during order processing as well as storing information in the database related to the quality metrics [299]. The system also providing an interface for customers to input quality ratings based on orders placed by the users to establish a past work quality rating within the system [300].

FIG. 32 illustrates one embodiment of the overall integrated workflow of the Made-To-Order portion and the Digital Manufacturing Enterprise portion of the system. The figures demonstrates that the system is comprised of modular controllers including a website modular controller, a I/O modular controller [302], a 3D web viewer controller [303], a database system controller [304], a 3D CAD Kernel or Engine [305], a production scheduling system controller [306], a stacking system controller [307]. A nesting system controller [308], a traveler geometry generation controller [309], a quality rating system modular controller [310], a remote manufacturing system controller [311], a material matching system controller [312] and a payment gateway system [313]. An Interface for defining digital travelers [314] and processing steps to generate traveler geometry [501], an interface to input special needs for the functionality of the nesting system [315], a method to input quality ratings [316], q method for the commercial user to define production resources, printers, materials and system functionality [317], define co-design constraints [317B] and define materials for design intent [317A]. The figure also demonstrates the general arrangement of the workflow describing the generation of 3D CAD Models or copies of 3D CAD Models via a website and subsequent system processing steps for manufacturing that begin with a process for manufacturing subroutine that begins the production planning, and execution portions of the workflow of the invention.

FIG. 33 illustrates an exemplary deployment of the invention including a website, displayed on a domain operated by a commercial user, offering by e-commerce, generated, at least in part, by the system controllers to retail customers [301] enabling retail customers to shop [503] for products within the e-commerce website portion. The figure additionally illustrates the ability to utilize the co-design interface within the system [504] to customize products before purchase. The figure additionally illustrates the commercial user enabling 3rd party contributors to upload and sell products in the system through the website [505] where 3rd party users may even be enabled to receive a sales commission [155] when the 3D CAD Models are sold and produced by the commercial user utilizing the invention. The illustration also demonstrates the ability for 3rd party users to upload and configure base 3D CAD Models for Co-Design [505] of 3D CAD Models and the commercial sale of products based in an ecommerce store based on the 3D CAD models uploaded, received, and stored in the system and produced at least in part by Additive Manufacturing through the workflow of the invention and additive manufacturing. The illustration further demonstrates the availability of an API or application programming interface [506] for enabling 3rd party integration into the invention.

FIG. 34 illustrates a physical exemplary embodiment of the invention as a commercial software system entitled Digital Factory and the Made-To-Order Digital Manufacturing Enterprise statement on the software box and representing a computerized system for both Co-Design AND Digital Workflow Management.

FIG. 35 illustrates an exemplary interface for defining and configuring a digital traveler feature for a base 3D CAD model uploaded to the system, in this case, a casting sprue containing digital traveler geometry [321]. The traveler functionality performed by the traveler modular controller [163] performing the processing steps demonstrated in FIG. 28. Note that the traveler functionality operates much like the co-design constraint system however; the interface is intended to be provided to the commercial user and not to the consumer user through the commercial user interface [156] for performing the traveler functionality [309]. The interface [314] enables the commercial user to configure traveler content for part tracking and identification.

FIG. 36 illustrates the system illustrated in FIG. 32 as deployed on general computing hardware and performing additive manufacturing workflow for a fleet of additive manufacturing machines defined and indexed in the system [254] by the commercial user and demonstrating the expandable capacity of the system for providing a flexible production system comprising the invention [325] and Additive Manufacturing production hardware exemplified where several of the illustrated 3D printer devices are specified as a metal AM printer [322], a wax printer [323] and a plastic printer [324] and or multiple discrete machined coupled or available to and indexed in the system representing production resources. The system therefore capable of using any existing or future additive manufacturing hardware since all additive manufacturing 3D printer devices use 3D CAD Models for input.

FIG. 37 illustrates an exemplary additive manufacturing printer device.

FIG. 38 illustrates the consumer user version of the co-design interface used within a website within an e-commerce session to co-design an exemplary class ring. The commercial user interface demonstrated in FIG. 2 is the commercial user version of FIG. 38.

FIG. 39 illustrates a payment processing gateway for performing commonly understood payment processing steps prior to allowing the 3D CAD Model(s) to be compiled by the Co-Design system and transferred to the order aggregation device of the digital MES portion of the system for production workflow operations performed by the system. The process started during a process for manufacturing subroutine [312].

FIG. 40 illustrates a letter from Additive Manufacturing Expert Todd Grim supporting the development of the invention to the United States Military.

FIG. 41 illustrates a support letter from Additive Manufacturing Experts Dr. Joe Beaman and Dr. Richard Crawford supporting the development of the system to the United States Military.

FIG. 42 illustrates a support letter from software and Manufacturing Experts Blain Wallace supporting the development of the system to the United States Military.

FIG. 43 illustrates a support letter from Dr. V. Jorge Leon, Manufacturing Engineering department head at Texas A&M University supporting the development of the system to the Texas Emerging Technology fund.

FIG. 44 illustrates a support letter from Jan Ripen, Texas Manufacturing Assistance Center supporting the development of the system to the Texas Emerging Technology fund.

FIG. 45 illustrates a graded college paper received by the applicant of which an A was received for a business management class during an MBA program for the development of the invention provided with a legal notice for confidentiality.

FIG. 46 illustrates the commercial nature of the invention embodied as system entitled Digital Factory displayed on an internet domain www.digitalrealitycorp.com as retrieved from the way back machine internet archive.

FIG. 47 illustrates the invention embodied as commercial software system entitled Digital Factory displayed at the domain www.digitalrealitycorp.com.

FIG. 48 illustrates an exemplary page of the proposal submitted to the United States Military for the development of invention under Small Business Innovation Research Grant Proposal MDA05-019 B053-019-0706 circa 2005 and marked proprietary.

FIG. 49 illustrates an exemplary use of the production management and scheduling interface available to the commercial user for the Digital MES portion of the invention for managing the fleet of additive manufacturing machines indexed within the system and representing production resources available to the system for workflow management. The system generated tray files are queued for production by the fleet of machines available and indexed within the system. The figure demonstrates the computer system having a database system [304], a production scheduling system [306], a stacking [307] and nesting system [308], a traveler system [309], a cad model aggregation device, a tray file production queue device, several packed tray files of 3D CAD Models and a fleet of additive manufacturing devices. The manufacturing devices are indexed within the system [254] by the commercial user as well as the system operating parameters for the nesting system [259] and stacking system [265], parameters for the traveler system [285], the material matching system [290] and other configurable operating parameters.

### DETAILED DESCRIPTION OF THE INVENTION AND PREFERRED EMBODIMENTS

Embodiments of the present invention will now be described in detail with reference to the associated drawings, in which preferred embodiments are shown. This invention may, however, be embodied in varying forms and should not be construed as limited to the embodiments set forth herein; rather, these embodiments are provided so that this disclosure will be complete and thorough, and will fully convey the spirit of the invention.

In one embodiment, the system deploying the method of the present invention, shall allow for the input of any geospatial/3D geometry design produced in a plurality of design software tools including but is not limited to Solidworks, Inventor, Rhino, Strata-Studio Pro, Maya, CA TIA, PROE, Alias Wave Front, Alias Sketch, Lightwave 3D, DesignCAD, Enovia Amapi, Carrera 4, Hexagon, Shade 3D, Poser 6, Axel Core, Recon 3D, Anatomica 3D, Adobe Dimensions, DeICAM, Form-Z, Mechanical Desktop, Pilot 3D, Solidthinking, Unigraphics, TouchCAD, as well as Solidworks, Inventor, Rhino, Strata-Studio Pro, Maya, CATIA, PRO-E, Alias Wave Front, Alias Sketch, Lightwave 3D, DesignCAD, Enovia Amapi, Carrera 4, Hexagon, Shade 3D, Poser 6, Axel Core, Recon 3D, Anatomica 3D, Adobe Dimensions, DeICAM, Form-Z, Mechanical Desktop, Pilot 3D, Solidthinking, Unigraphics, TouchCAD an online tools such as OnShape.

The present invention therefore can accept and utilize any 3D CAD Model geometry created utilizing one of the aforementioned geospatial/3D graphics application because 3D graphics applications export 3D models for cross compatibility purposes into many common 3D file formats.

in one embodiment, the limitations on what can be manufactured using this method and system as described herein are defined by the materials available to an additive fabrication machine and an ability to adequately define a 3D object to allow for its printing via additive fabrication means.

In one embodiment, the system could be deployed in manners which negate the need for pre-payment prior to production. For example: in delivering an order of a product to a business client who purchases on a purchase order or where no payment is required such as battlefield forward manufacturing or where the order is a repeat-order.

As used herein, the terms “communication network” and “Internet” refer to any networking method that provides a user/customer access to the system described herein from a remote geographical location. The communication network providing two-way data communication between the user/customer accessing a website or web portal located on the World Wide Web which interfaces with said system.

As commonly understood by someone skilled in the art of the internet or e-commerce, a website or web portal refers to one or more web pages that collectively comprise a website, the website being accessible over a communication network from remote geographical locations and transferring data including but not limited to HTML, Java, or any other computer-based data, to and from a user and or user computer from one or more remote computer systems. Said website containing, for example; images, HTML, CGI, JAVA, FLASH, AXAX., ACTIVE X CONTROLS, VIDEO and other computer code to present a useful tool to a user/customer visiting the website. Said data representing content intended for a user/customer to view, interpret, and utilize for a purpose as understood commonly by anyone skilled in accessing and using the internet or World Wide Web.

In one embodiment, the website provides by the current invention includes multiple web pages, collectively comprising a website, with a home page whose meaning is clear to anyone skilled in the art of the internet and e-commerce. The website is accessible by a web browser in response to a user/customer http request resulting in the presentation of the website through its URL by which all web pages are categorized, organized and located on the internet.

in one embodiment, a user/customer as described herein can include any person who accesses a website on the internet for the purpose of gathering information, learning, experiencing, or purchasing by e-commerce. This description is extended to users who may be involved in collaborative design efforts. The terms described here are provided to represent, rather than limit, the terms describing a user/customer.

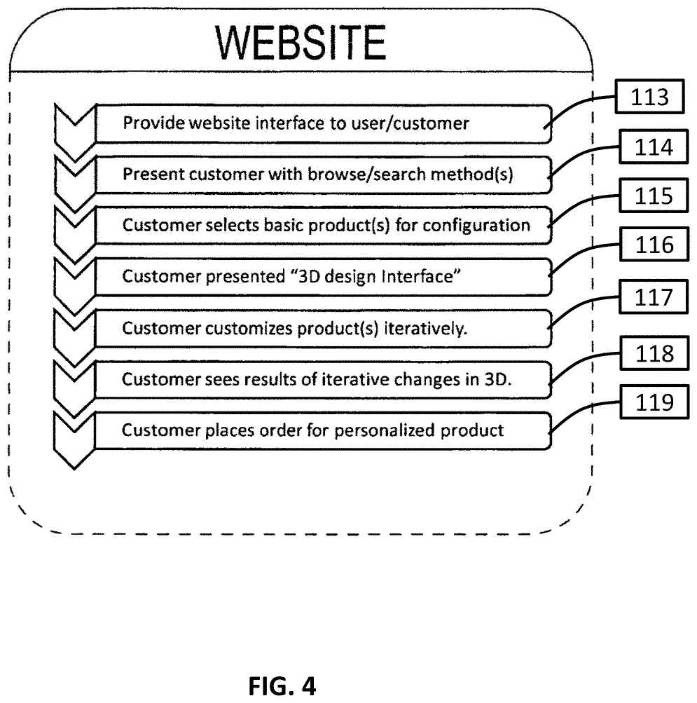

In one embodiment, the website or web portal depicted in FIG. 4 is designed to provide users desiring to customize for the intent of purchase, personalized or customized products including any product which may be adequately represented by 3D geometry so as to allow 3D printing via Additive Fabrication methods. The website further contains one or methods to browse and or search for products contained in said system to customize or personalize and purchase. Said website or web portal further provides the means by which the user may access the system that provides the user an interface through which they may personalize or customize aspects of a product including but not limited to; color, shape, texture, function, thermal, mechanical, electrical properties, location of appendages or other 3D geometries affixed to a core product, including text, fonts, scale or other parameters of text which may be manipulated whereby said Text becomes manifested as 3D geometry or 2D geometry on the surface of a 3D geometry wherein the ability to see such 2D geometry is meant to include any means which differentiates it from the surrounding material to make it legible including but limited to color or texture.

Product manipulation and design parameters are intended to mean any modification which is feasible via geospatial/3D design modifications to a 3D object which does not violate its fit, form or function. Furthermore; product manipulation and modifications refer to any design detail or modification that augment or enhance the original product to meet an individual or personal need or desire.

Individual or personal enhancements may also include user/customer original design modifications by someone skilled in the art of 3D design and design implementation so as to create undefined enhancements to a product or an entirely new product design having the same purpose or an entirely new purpose.

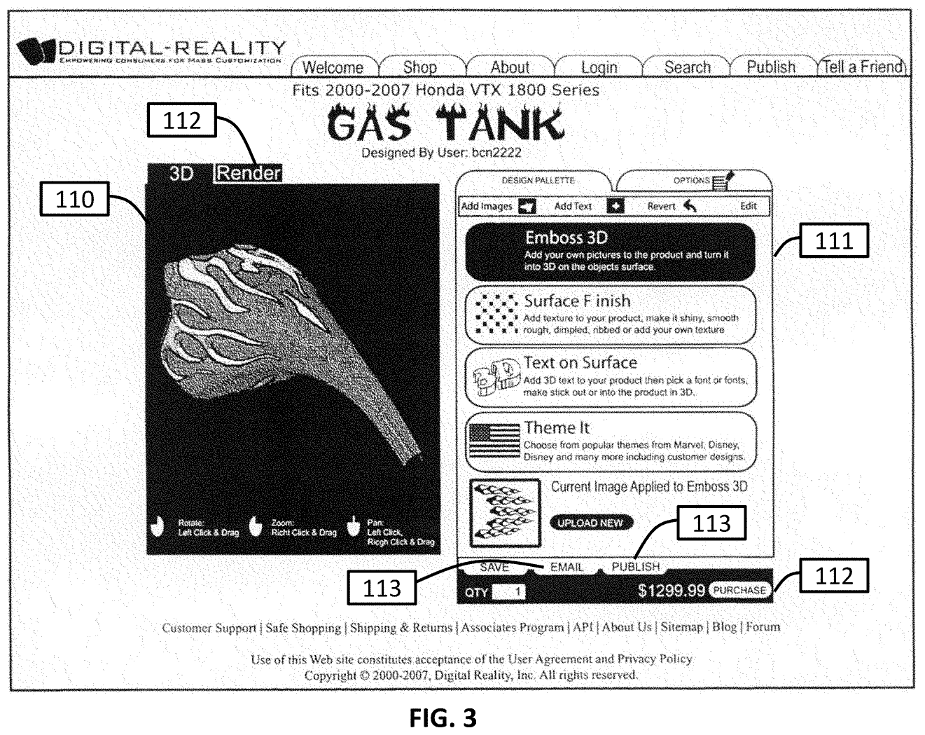

The website or web portal of FIG. 3 includes the ability to include rendering [112] 3D CAD models for a user/customer allowing the customer to see the closest approximation of the actual physical product that is superior to all other visualization methods because the 3D entity they visualize is in fact the digital representation of their actual product.

A computer or computers deploying the method and system of the invention may include any computer system as commonly understood by anyone familiar with the common definition of a computer including computer systems with processor(s), temporary & permanent storage mediums, input/output controls, network connectivity and an operating system. Furthermore, said computer(s) contain programming code in any known explicit or implicit method whereby the code described is responsible for, solely, or in combination with hardware, causing the computer(s) to carry out operations to provide the method of the present invention described herein. Said software and or hardware clearly understood to carry out the purpose as defined to anyone skilled in the art of computers and networking.

A distinction is made between a computer or computers carrying out systems and methods usable within the scope of the present invention and a user/customer computer, whereby a user/customer accesses the computer or computers carrying out, by way of computer software and hardware, the methods of the present invention. A user/customer computer can include a PC, Smartphone, home computer, desktop computer, notebook computer, tablet PC or combination thereof.

To further explain the method and system, detailed description is provided for the remaining diagrams and drawings:

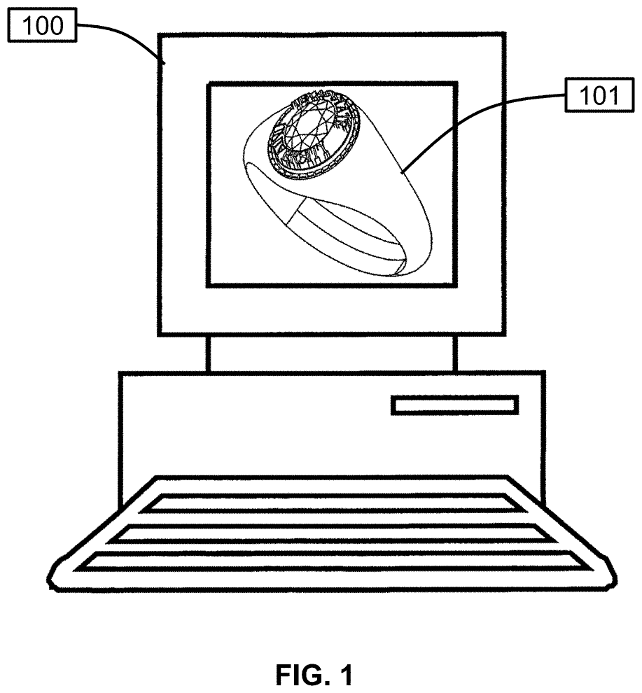

FIG. 1 illustrates a personal computer or workstation [100] utilized by a CAD Designer or engineer to create a CAD Model, using a CAD Design software package of the types available from many commercial providers [101]. The Base 3D CAD Model is uploaded to the system of the present invention. The system deploying the method of the present invention, shall allow for the input of any geospatial/3D geometry design produced in a plurality of design software tools including but not limited to Solidworks, Inventor, Rhino, Strata-Studio Pro, Maya, CATIA, PRO-E, Alias Wave Front, Alias Sketch, Lightwave 3D, DesignCAD, Enovia Amapi, Carrera 4, Hexagon, Shade 3D, Poser 6, Axel Core, Recon 3D, Anatomica 3D, Adobe Dimensions, DeICAM, Form-Z, Mechanical Desktop, Pilot 3D, Solidthinking, Unigraphics, TouchCAD, as well as Solidworks, Inventor, Rhino, Strata-Studio Pro, Maya, CATIA, PRO-E, Alias Wave Front, Alias Sketch, Lightwave 3D, DesignCAD, Enovia Amapi, Carrera 4, Hexagon, Shade 3D, Poser 6, Axel Core, Recon 3D, Anatomica 3D, Adobe Dimensions, DeICAM, Form-Z, Mechanical Desktop, Pilot 3D, Solidthinking, Unigraphics, TouchCAD an online tools such as OnShape.

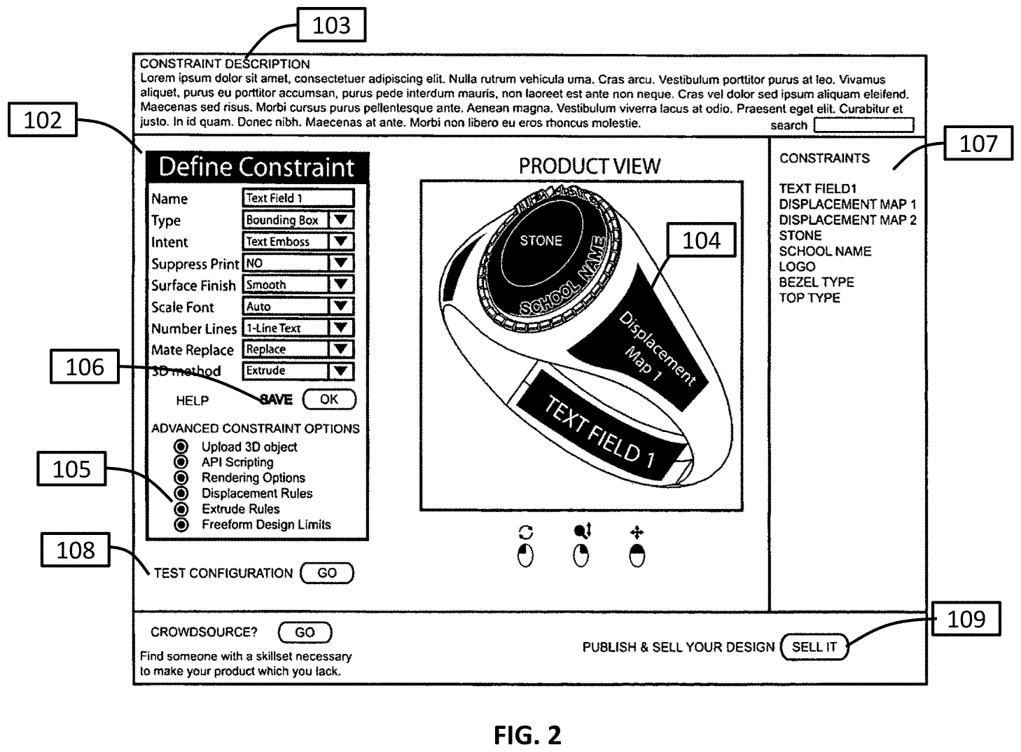

FIG. 2 illustrates an embodiment of the Co-Design configuration interface for defining and configuring Co-Design features or constraints. The interface enables the first commercial user the ability to define constraint features, parameters, specifications, and values [102] that are referenced as CAD Kernel functions within the system to alter the geometry of the base 3D CAD Model during a Co-Design session, as well as to input a description of the Constraint features and a description of the product [103]. The interface and its functionality additionally enable a user to define regions and zones for each defined constraint to be applied on the base 3D CAD Model [104] and provides advanced constraint definition tools [105] or any geometric modifier possible by CAD Kernels. When the Save button [106] is pressed, the system stores the configured parameters for the current constraint, the current constraint becomes a modification “feature” having a name, and associated values related to the 3D CAD Model in the system [107]. The Co-Design interface additionally provides the ability to test the configured constraint features as a co-designer or consumer user would see the product in a browser session [108]. The commercial user may then “publish” the base 3D CAD model having one or more constraints as a co-designed 3D CAD Model having the Co-Design features associated with by publishing the 3D CAD Model as a product in the Web Shopping cart system [109] or course, the commercial user may also publish the 3D CAD Model without defining any constraints or the consumer user may opt not to configure any of the defined constraints and purchase the design as-is.

FIG. 3 illustrates an embodiment of a web page commonly referred to a product fly page in e-commerce parlance. The web page reflects an electronic shopping cart system adapted to enable the Co-Design method within the cart interface. The web page showcases a product that is represented by one or more 3D CAD Models [110]. The Interface provides a viewing option prepared by the system and caused to be displayed on the user device by the system [110] within the ecommerce page where previously configured constraint features are displayed graphically to the user as options for altering the geometry of the base 3D CAD Model [111] according to the constrain definitions previously defined by the seller and where the constraint features defined are associated with graphical elements relating to defined geometric modifiers available from the 3D CAD Kernel(s) associated with the system. The user intending to acquire the product, may alter the design by interacting with the interface which in turn occurs by the user selecting visible functional icons that case the system to apply functions that alter the base 3D CAD model utilizing computer instructions present in the modular controllers of the system. The user may see not only the 3D view of the CAD Model but also see a rendering of the 3D CAD Model [112] also prepared by the system. When satisfied, the user having Co-Designed the 3D CAD Model representing the product may request to obtain the product represented by the 3D CAD Model as well as other functionality [113] [114].

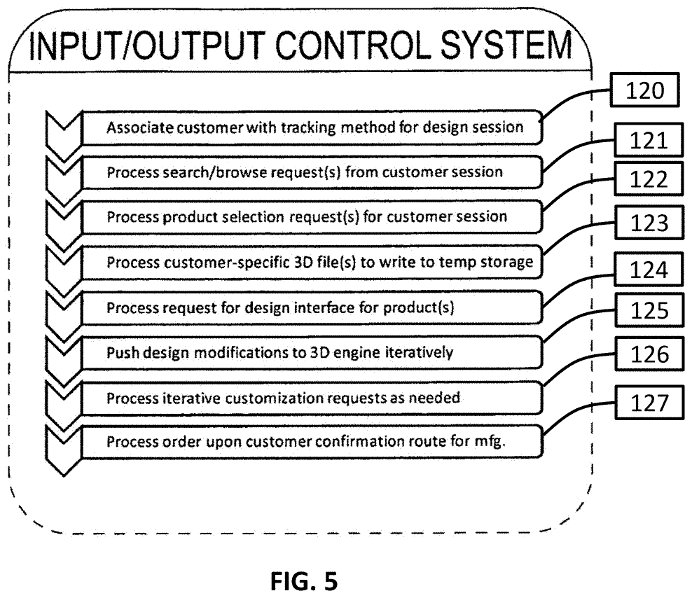

FIG. 4 illustrates the computing operations performed by the modular e-commerce website system controller [183] portion of the invention illustrated in FIG. 5. The modular system generates and causes to be displayed, at least portions of a website or web page on the users/customer device and may include a browse and search function for searching the catalog of products [114]. The system receives a selection of the product through the system-provided interface [115] and the modular system prepares and causes to be displayed on the user device, the consumer customization interface demonstrated in FIG. 3 [116]. The system processes commands for applying the geometric alterations to the base 3D CAD Model [117] and the user is iteratively provided an updated view of the alterations caused to be performed by the user which are processed by the system [118]. The system accepts a request to place the order to obtain the product [119]. Of course, e-commerce systems also accept other information such as payment types, shipping location information, quantity and other common information needed for processing an order. As denoted by the illustration, the system may provide the functionality by API.

FIG. 5 illustrates processing steps performed by the modular input/output or input/output system [157] for coordinating system commands between a user/customer and other modular controllers contained within the system. The “input/output” control system demonstrates certain commands performed by or functions of the input/output control system. The system processes requests to obtain a product represented by the 3D CAD model [120] and processes the actual 3D CAD model data files, processes catalog browse requests [121] and product selection requests in order to then display the product in the flypage and initiates the user interface [122]. The modular controller also processes requests for the base 3D CAD model for a user session for presentation in the web interface [124] and causes the system to process 3D CAD Model geometry alteration requests [125] through a 3D CAD Kernel or “engine” which is also a modular controller within the system. Throughout the Co-Design process, the input/output system iteratively processes subsequent Co-Design modifications to the base 3D CAD model through the 3D CAD Kernel as requested, depending on the selected function [126]. Finally, the input/output system provides an execution command that initiates a process for manufacturing command [127] that causes additional system steps to be performed. The input/output system modular controller initiates a set of subroutines to produce a physical copy of the 3D object by Additive Manufacturing, triggering processing steps that are novel to the Co-Design systems and methods. Of course, this module is capable of being run on any computer and by independent commercial users running e-commerce systems arranged to perform the e-commerce operation in the manner described that is particularly useful for Additive Manufacturing.

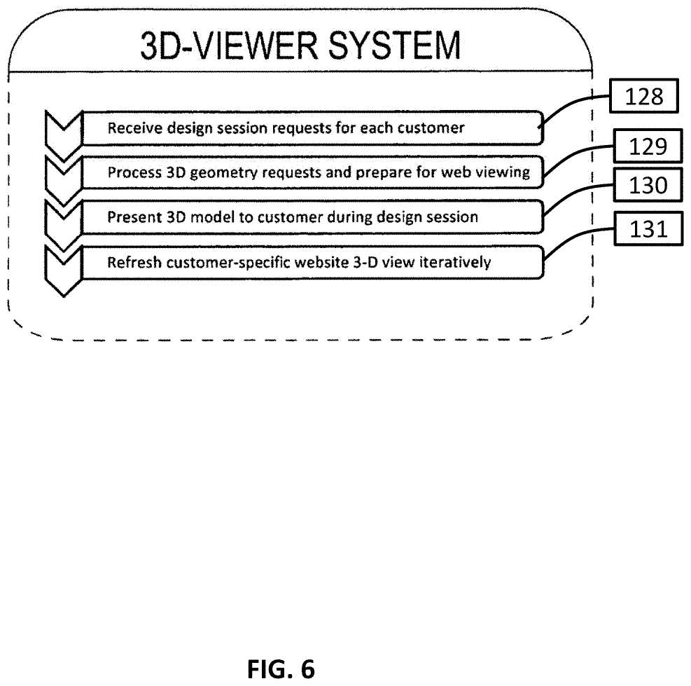

FIG. 6 illustrates processing steps performed by the modular 3D-Viewer controller system [158] which provides functions that includes establishing a design session for each user of the system when accessing a web page [128], and receiving requests from a modular I/O controller system to process a base 3D CAD model in a manner that creates a web-compatible version of the base 3D CAD Model [129] and causes a web-compatible view of the 3D CAD Model to be displayed on the user device [130] and iteratively causes additional web compatible views of the 3D CAD model to be displayed on the user device as needed during a Co-design session in a web page. Of course, as demonstrated, the displayed 3D CAD model may take the form of a 3D representation of the CAD model from the system or a system generated pixel-based rendering of the 3D CAD Model by methods such as Raytracing, radiosity, Phong shading or Gourad shading or other methods.

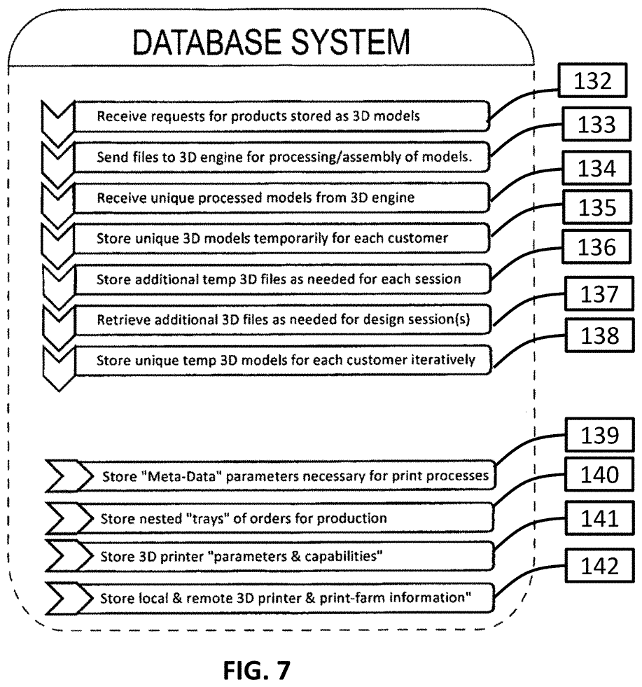

FIG. 7 illustrates processing functions performed by the modular database [162] system, including; retrieving 3D CAD models from the database or file system [132] and receiving requests from a system to parse 3D CAD models through a 3D CAD Kernel [133] for varying functions as well as delivering 3D CAD models to other modular controllers [134] such as the web viewer module which may request a 3D CAD model from the database and or file system based on a co-design session initiated in a website. The dataset and or file system and associated controllers may also store temporary 3D CAD model data in a database or file system for each unique customer [135] as well as fetch additional 3D CAD models for a user during a design session [136] or for processing by other processing controllers and modules [137], receive and store temporary 3D CAD Models [138], storing “meta-Data” parameters necessary for print processes [139], storing nested tray files for production [140], storing 3d printer printing device parameters and capabilities [141] and storing remote or geospatially located 3D printer device capabilities [142] such as those available from a remote product facility.

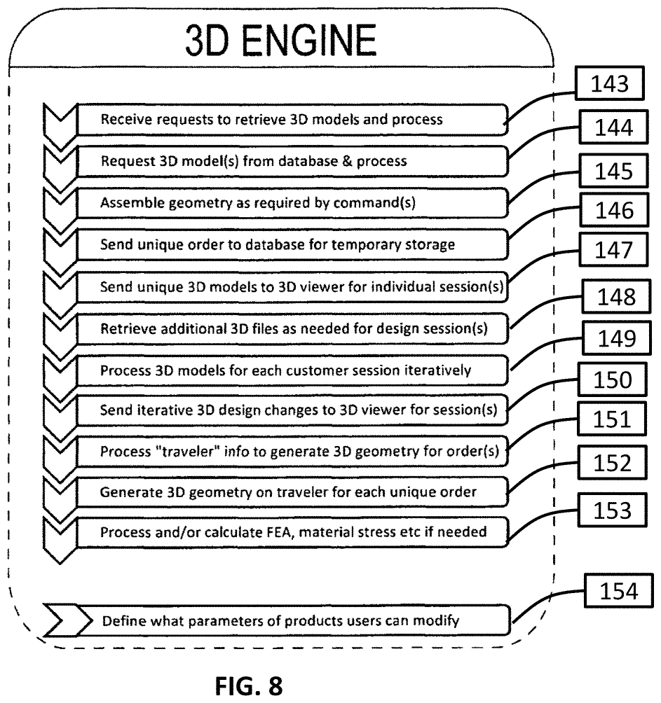

FIG. 8 illustrates processing steps performed by the system as requested and processed using the 3D Kernel or engine system [159] including; requesting that a 3D CAD Model be retrieved and “parsed” by the Kernel, meaning it is processed to accomplish a geometry change according to a selected function [143]. retrieved 3D CAD Models from a database or file system [144], performing a mate function [145] which is essentially joining two or more 3D geometries virtually or rather merging data of two 3D objects in a manner that defines their relative position to one another, an output command to store 3D CAD models in a buffer or file system or database [146] transferring 3D CAD model data to a web-viewer module for further processing in order to parse and prepare an iterative updated web compatible view of a 3D CAD model during a Co-Design Session [147] and process iterative requests for such tasks [148] including unique customer sessions in a co-design system [149], iteratively updating the web view after each processed function is performed [150], processing traveler geometry functions [151] using the 3D Kernel to generate the 3D Geometry containing the traveler information defined in the traveler feature, [152], providing 3D CAD Model analysis comprising parsing 3D CAD model data file and processing it, using the 3D CAD Kernel or engine to determine the models physical performance based on material selections [153] and enabling the configuration of co-design constraints by a commercial user within a browser session that define Co-Design features against a base 3D CAD models uploaded to the system [154].

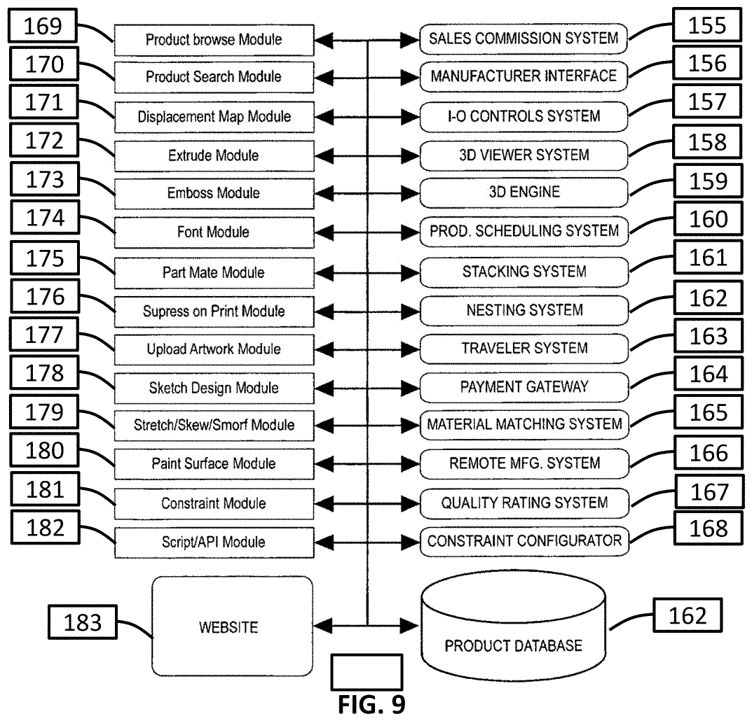

FIG. 9 illustrates the modular nature of the overall Made-To-Order Digital Manufacturing Enterprise system comprised of containerized or modular controllers. Each controller comprised of software arranged for performing computing steps on general computing hardware and arranged to provide an array of processing functions in a manner particularly useful for Additive Manufacturing. It is additionally illustrated that the system is interconnected between the modular controllers exemplifying that the system controllers are designed and arranged to provide input and output of data by and between the modular controllers regardless of physical computing location. In particular, attention is drawn to the Application Programming Interface (API) [182] module which, according to commonly understood computing practices provides methods to enable the various modular controllers to be able to communicate between each other and for 3rd party users to integrate and control the system. The figure generally divides the made-to-order portions, on the left side of the figure, from the Digital Manufacturing Enterprise system or Digital MES portion of the invention on the right side. Each containerized application working in and arranged to function in conjunction with other modular controllers. The arrangement and use of the various portions of the invention may therefore be used or not used by the commercial user of the system and likewise by a 3rd party user using the system.

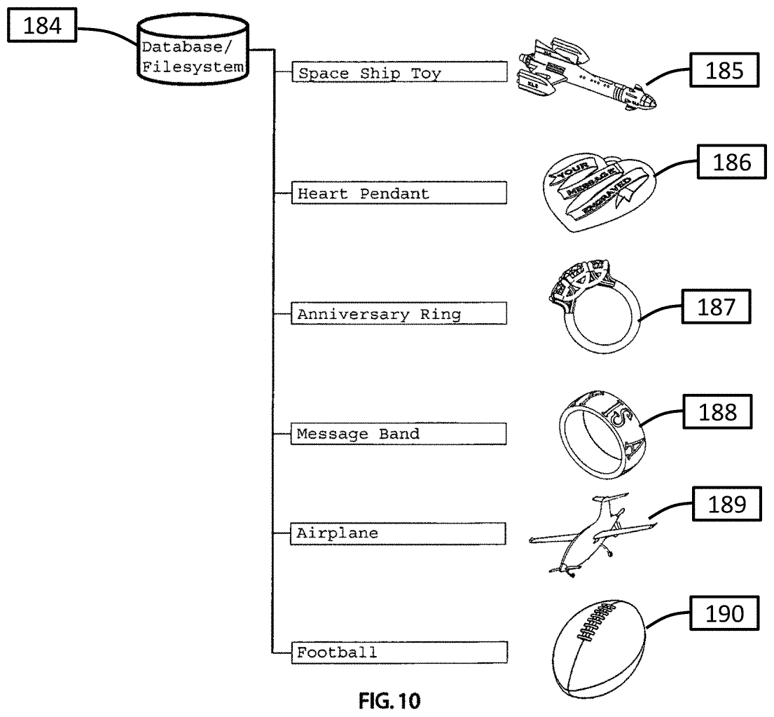

FIG. 10 illustrates, 3D CAD Models described in computer files and representing “products” stored in a database [184] or file system. Examples of the products include a spaceship top [185], a heart-shaped pendant or charm [186], an anniversary ring [187], a message band [188], an airplane model [189] and a football charm [190]. Of course, the database or file system can also be a PDM/PLM system as employed by Commercial Enterprises. Revision controlled documents are available from PDM/PLM systems.

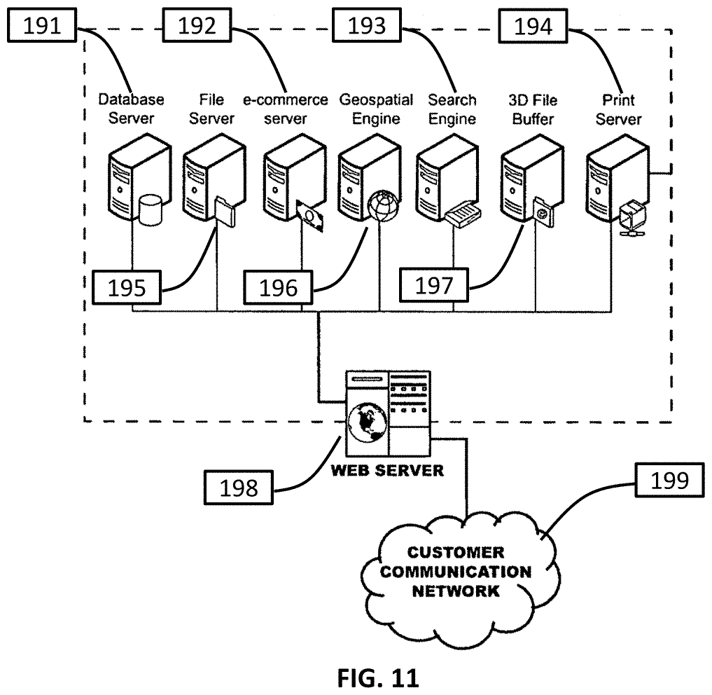

FIG. 11 illustrates an exemplary configuration of a deployment model of the invention comprising; a group of server devices providing database functionality for bulk storage and retrieval operations of the operation of the system [191], the e-commerce system operating on a separate computer server [192], Search functions [193] operated on a separate computing device, a 3D Printing print server [194] operated on a separate computing device, a file server [195] operated on a separate computing device and storing 3D CAD models, the Co-Design system operated on a separate computing device, a 3D file buffer for temporary storage and retrieval of 3D CAD model data [197], a web server [198] enabling a plurality of users simultaneous access to the operations of the system over a communication network [199] where the computer servers, utilizing the modular controller software performs the invention. The physical location of each server is not relevant to the functionality of the system. The figure also illustrates the opportunity for portions of the system to be divided amongst commercial users.

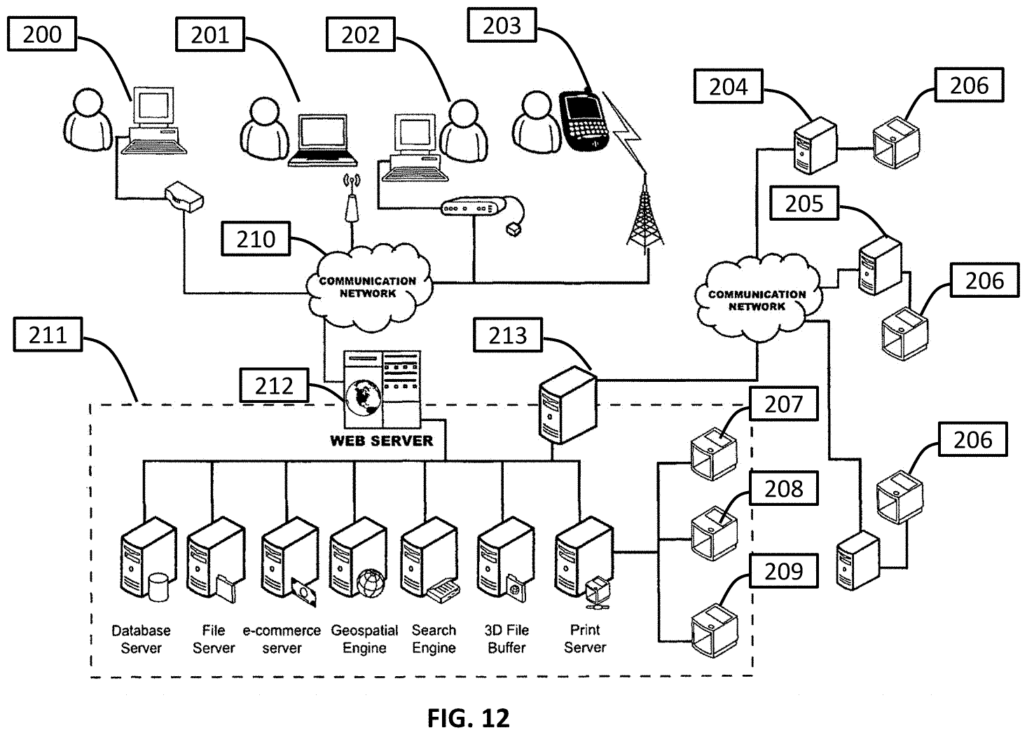

FIG. 12 illustrates access to the invention by users utilizing a home PC [200], a notebook computer [201], a mobile cellular device [203] which communicates through a communication network [210] enabled by a the web server [212] to provide system functionality demonstrated within the dashed line of an array of computer servers performing the functions of the invention utilizing the software and general computing hardware. The figure additionally illustrates a distributed manufacturing server device [213] enabling communication with geospatially located additive manufacturing facilities. Each remote manufacturing facility having at least one computing device [204] and each remote facility [205] having Additive Manufacturing device(s) [206] for production of products from 3D CAD Model build files transmitted to the remote facilities and received from the system [211] over a communication network. The remote facilities accessing the Digital MES portions of the system over the communication network, using the computing device at each facility or bureau. The figure additionally illustrates Additive Manufacturing devices located locally and available for production of parts by additive manufacturing from build files prepared by the system. For example, these machines might include a wax printer [207], a DMLS printer [208] or a plastic printer [209]. The system functionality is illustrated herein to enable distributed manufacturing. Distributed Manufacturing denotes that each of the remote computing devices is also using the Digital MES portion of the invention at their location for aggregating, organizing, arranging, scheduling, and packing tray files for production on local printer devices.

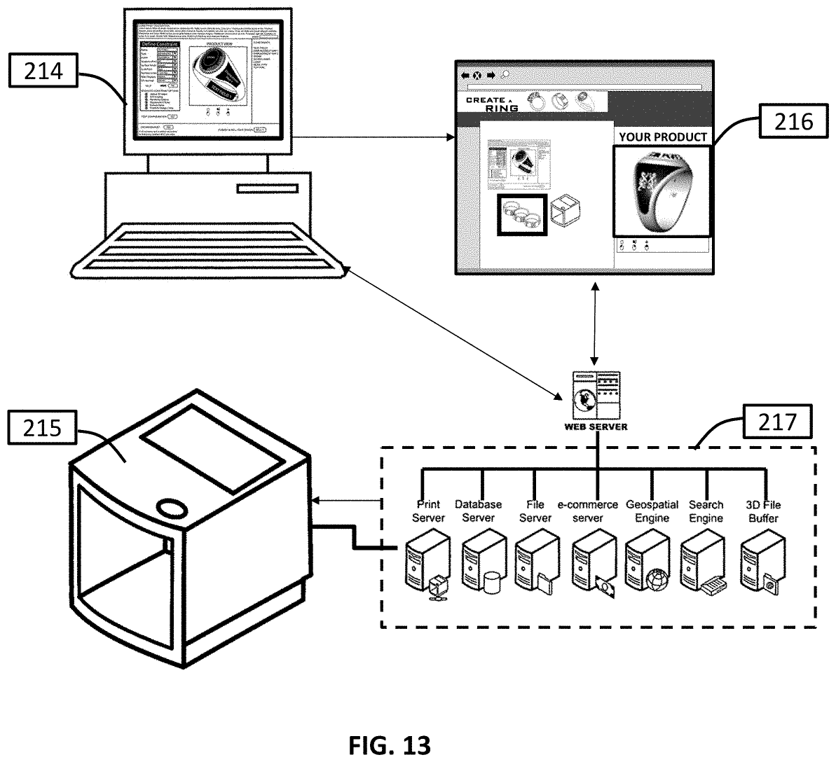

FIG. 13 illustrates an abbreviated or simplified representation of the operational model of the invention. A CAD designer creates a base 3D CAD Model [213] and uploads it to the system. The system is configured to receive and store the model as a product and to present an online catalog of such 3D CAD Models to consumers on a web page in an e-commerce fashion. The consumer is able to make a selection of a product represented by one or more 3D CAD Models from a catalog of 3D CAD models presented on the web page and may receive and have displayed on the users computing device, an interface [216] that includes the Co-Design interface. The invention is exemplified as a computing system [217] handling the computerized operations and workflow management of the invention and arranged to transfer build files generated by the system to a 3D Printer device [215] for output. In this figure, a Solid-Scape wax casting pattern for Lost Wax Investment Casting.

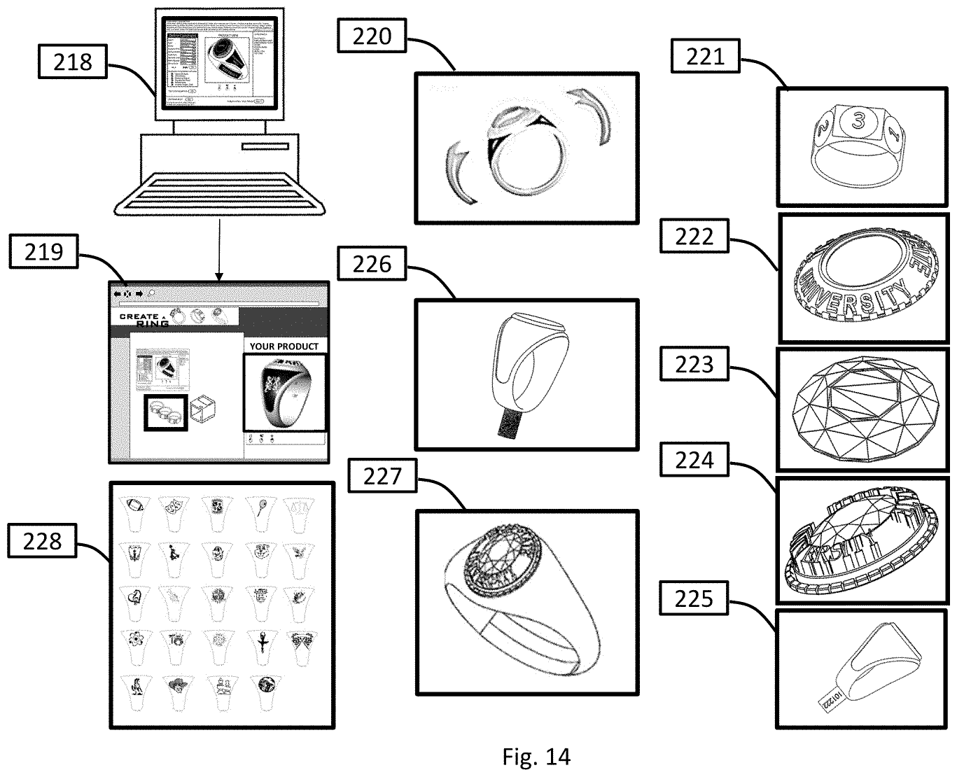

FIG. 14 illustrates an exemplary embodiment of a commercial use case of the invention for design, sale and manufacture of custom Class rings including; the design of 3D CAD Models [218] designed in any 3D CAD Modeling package and comprising a core of a ring [221], a bezel or crowns [222] containing a co-design text feature configurable by a consumer user, a gemstone [223], a combined gemstone and crown [224], a core with a casting sprue [225], shank art panels [220], a core having a shank suppressed [226] in a web view, a complete 3D CD Model representing a class ring [227] and an array of 3D CAD models held within a database [228] and representing optional configurations available for the class ring and an interface [219] for the selection, Co-Design and purchase of the product—represented by 3D CAD Models within the system. The figure also illustrates how the component CAD models are assembled and exchanged [221] using the shanks [228] and shows the sprue [226] that is hidden during the consumer session [219] using the retail interface [218] that is generated as geometry containing a digital traveler feature [225] and a final product [227] comprising a ring with a real gemstone that is not printed.

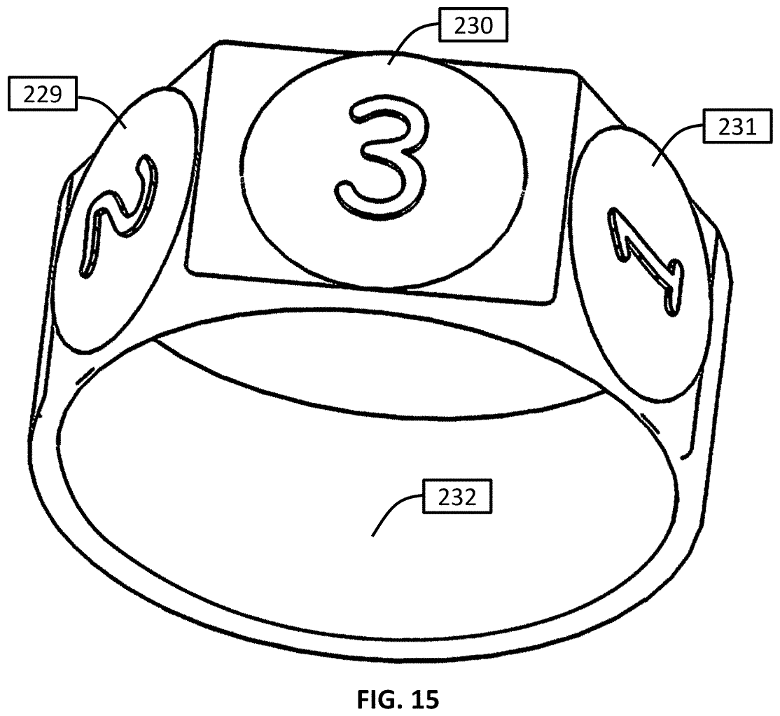

FIG. 15 illustrates a general concept for a class ring comprised of multiple interchangeable 3D CAD model parts. Each part mated to the core [232] by a part mate function controller [175] and representing a left-hand shank showing a 2 on the panel, a bezel [230] showing a 3 on the panel, a right-hand shank [231] showing a 1 on the panel. Each panel interchangeable by computer function within the system performing the Made-To-Order portion of the invention.

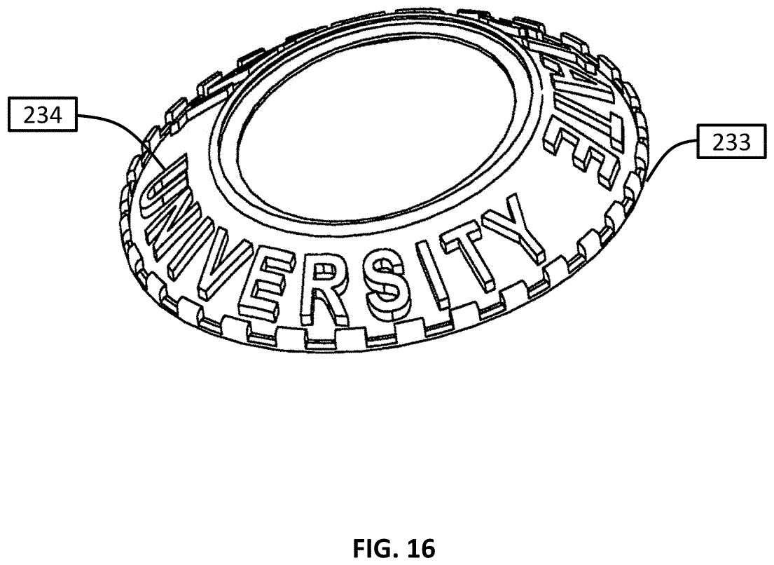

FIG. 16 illustrates a configured co-design constraint feature for text. The text feature [234] is configured in the Co-Design interface as a feature to the base 3D CAD model, which is in this case, a class ring bezel [233]. The constraint is defined in the co-design interface illustrated in FIG. 2.

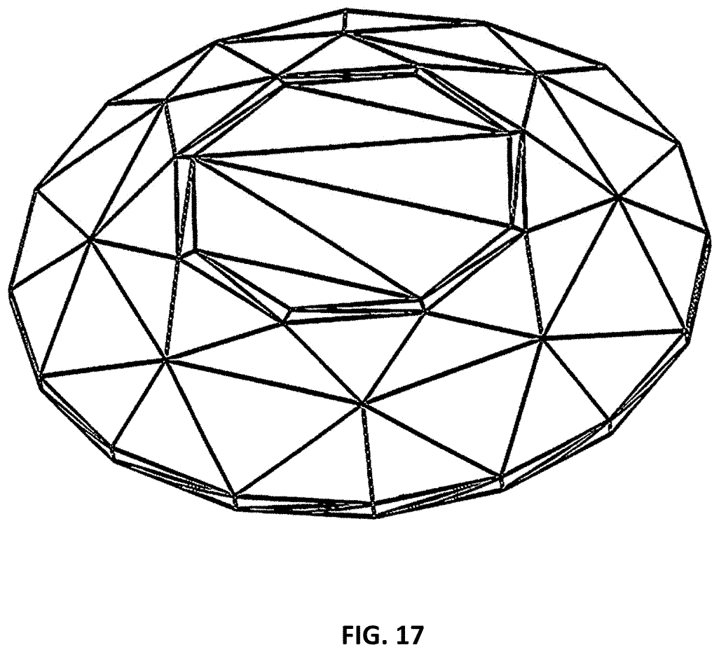

FIG. 17 illustrates a gemstone which is common in jewelry. The inclusion of the 3D model of gemstones within the system is a necessary feature because otherwise the ring products would appear odd to the users in an e-commerce environment and therefore included for visual representation only because gemstones are in many cases natural made and not 3D printed.

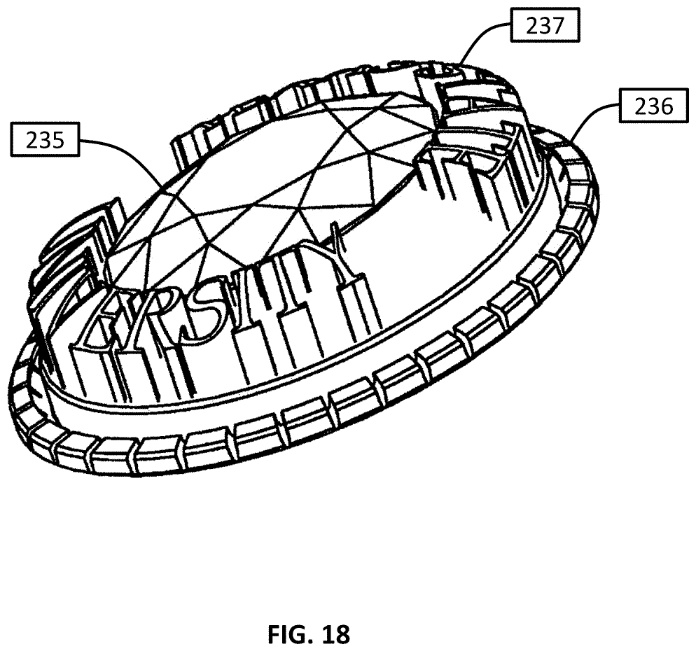

FIG. 18 illustrates a gemstone [235] 3D CAD model mated by a part mate controller [175] to a 3D CAD model of a bezel [236] and having a configurable text feature co-design constraint function as an extrusion in 3D [237] performed by an extrude module [172] and font module [174] and generated by the 3D Kernel or engine [159].

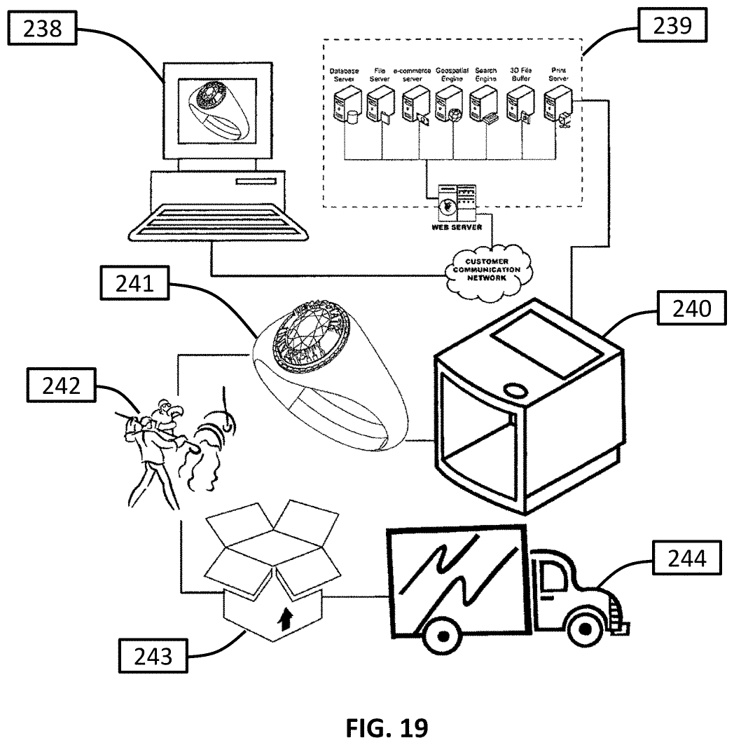

FIG. 19 illustrates a novel commercial business model utilizing the system for on-demand manufacturing by additive manufacturing of class rings or other custom jewelry including consumers shopping online [238] via website enabled by the invention and served to the consumers by the method and system [239] which is used to generate Co-Designed 3D CAD Models and prepare them for production by 3D Printing. In the case of jewelry, 3D printing [240], in this example, produces a wax pattern [241] which is used for lost-wax investment casting [242] and then prepared and packaged for shipping to the customer [243] by customary delivery methods [244]. The business model is applicable to many other market verticals.

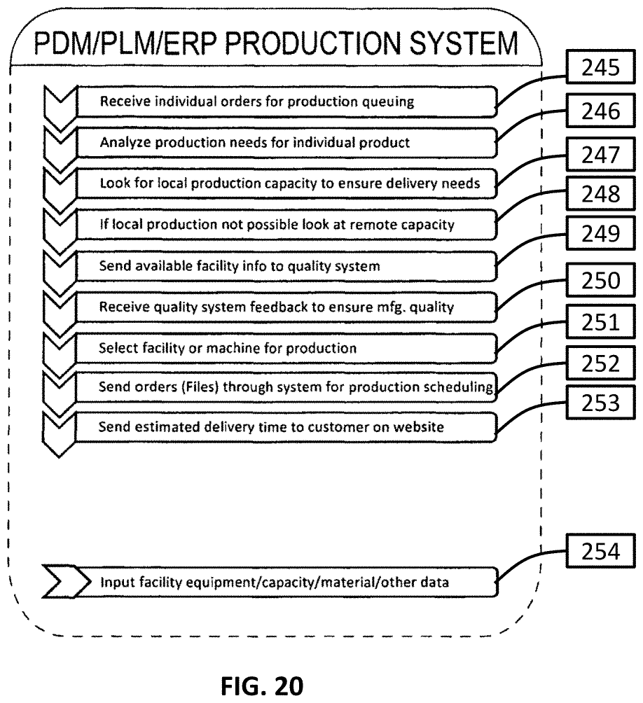

FIG. 20 demonstrates system processing steps performed by the modular production system controller or “production system”. The system is programmed to use general computing hardware to perform the processing steps. The orders are represented by a 3D CAD Model and meta-data describing the production criteria for the 3D geometry. The processing steps include; receiving orders for production queuing [245], analyzing the production needs for the 3D CAD model [246], determining an organization production plan for the 3D CAD models locally [247] and remotely [248], determining quality ratings of remote production facilities [249] and using the quality data to make a determination to use a remote facility indexed in the system [250], selecting a 3D printer device indexed within the system locally or remotely [251], routing orders through additional processing steps through the system based on the analysis performed an organization production plan determined by the system [252] the order for production according to production scheduling techniques [252] and generating and providing an estimated delivery time based on estimated production lead time [253]. The controller additionally enables commercial users to input production equipment information including quantity, type, materials [014] and other criteria utilized by the system for organizing, arranging, scheduling, and routing 3D CAD Models through the system [254]. The figure also illustrates the production system including a Product Data Management System, Product Lifecycle Management System and ERP functionality along with the Additive Manufacturing Production System functionality.

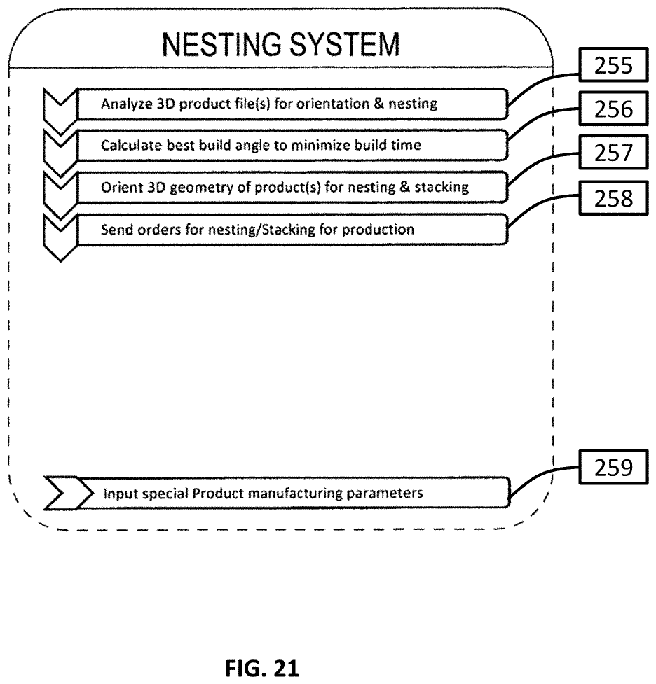

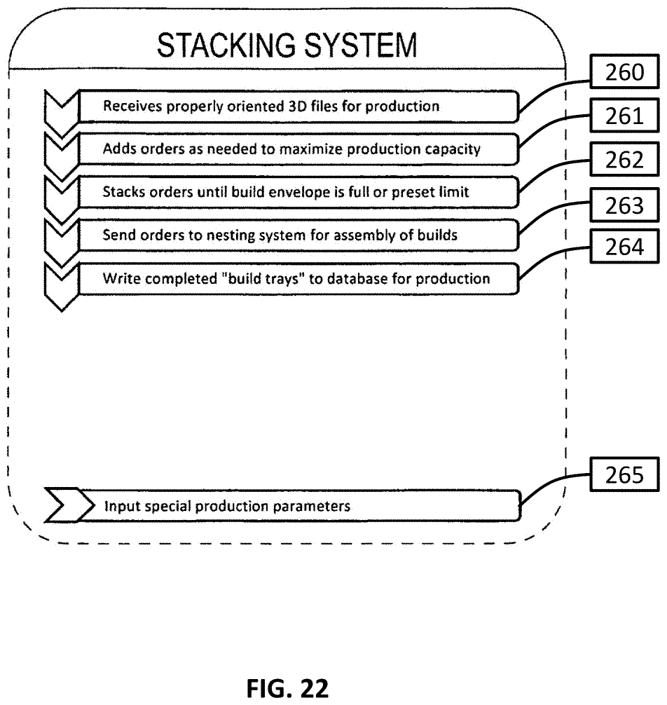

FIG. 21 demonstrates system processing steps performed by the nesting system modular controller [162] which performs system processing steps of; parsing and analyzing 3D CAD model geometry within 3D CAD model files for orientation, determining the optimum build angle to minimize build time for the model based on the analysis [256], re-orienting the 3D CAD model geometry for nesting and staking operations based on the determination [257], processing in conjunction with the stacking system modular controller [258] shown in FIG. 22 and accepting commercial user input for parameters for the nesting system operations [259].

FIG. 22 demonstrates system processing steps performed by the stacking system modular controller [161] which performs system processing steps of; receiving re-oriented 3D CAD model file geometry for production [260] from the nesting system [258], electronically and virtually adding the 3D CAD Models processed to an arrangement of 3D CAD model files [261] based on a build envelope or printable area defined in the system [262] or reaching a preset limit and writing a completed nested arrangement of a batch or group or subset group of 3D CAD models to a “tray” file [265] which is a nested arrangement of the batch or group of individual 3D CD model files combined in a single computer file called a tray file and representing a build file of packed 3D CAD Models fitting with the bounding box of used to control, at least in part, an additive manufacturing device to produce the geometry within the tray file. The figure also reflects the preparation of arrangements of 3D CAD model file geometry fitting with the printable area or bounding box of a 3D Printer device based on parameters defining the printable area or bounding box of an Additive Manufacturing device and processing steps of the nesting system [162] and stacking system [261] for a 3D printer device.

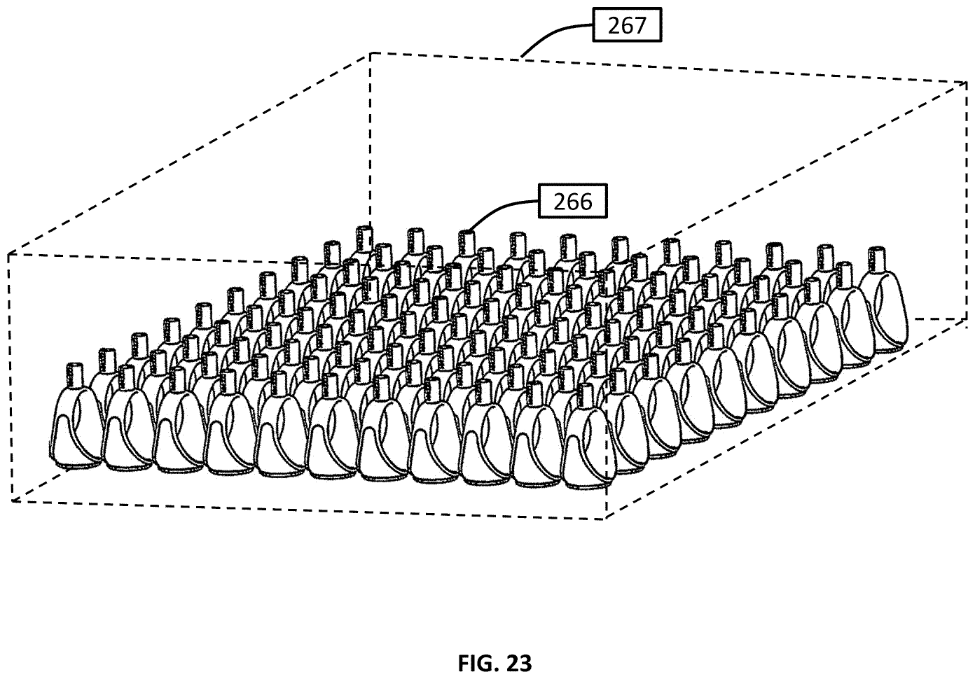

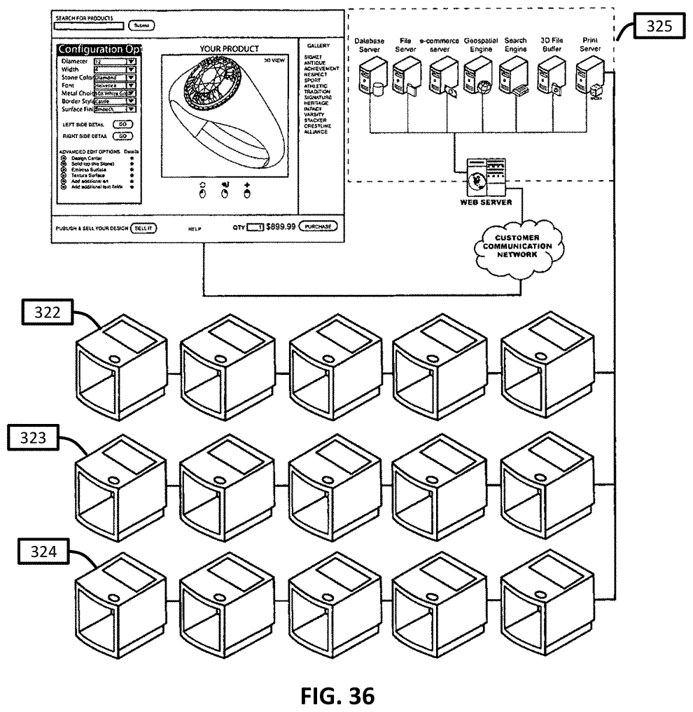

FIG. 23 illustrates the output of the system processing steps jointly performed by the stacking system modular controller [161] and nesting system modular controller [162]. The figure reflects a nested and batched arrangement of 3D CAD model file geometry [266] fitting with the printable area or bounding box of a 3D Printer device [267] based on parameters defining the printable area or bounding box of an Additive Manufacturing device having an indexed profile in the system by a commercial user [254] and processing steps of the nesting system [162] demonstrated in FIG. 21 and stacking system [161] ] demonstrated in FIG. 22 and representing an arrangement of 3D CAD Models for production by a printer device as illustrated in FIG. 36.

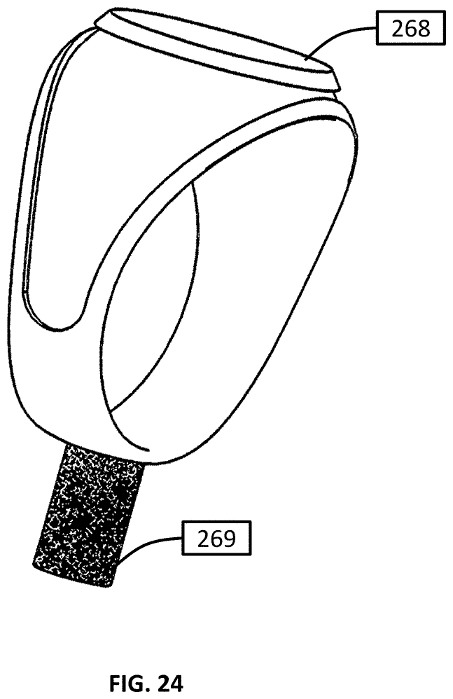

FIG. 24 illustrates a class ring core [268] and an appendage [269] commonly known to one known in the casting manufacturing industry as a sprue. A sprue is used as a flow path for molten metal in the lost-wax investment casting process. The sprue in this case provides two benefits, a casting sprue function, and a digital traveler feature function. The Traveler feature function is black or dark solid colored to reflect its function and that it may be suppressed from view in the web browser during a Co-Design Session. It is suppressed because seeing this geometry feature would be confusing to a retail user. The Sprue is 3D printed however, meaning the geometry is not suppressed in later stage system processing.

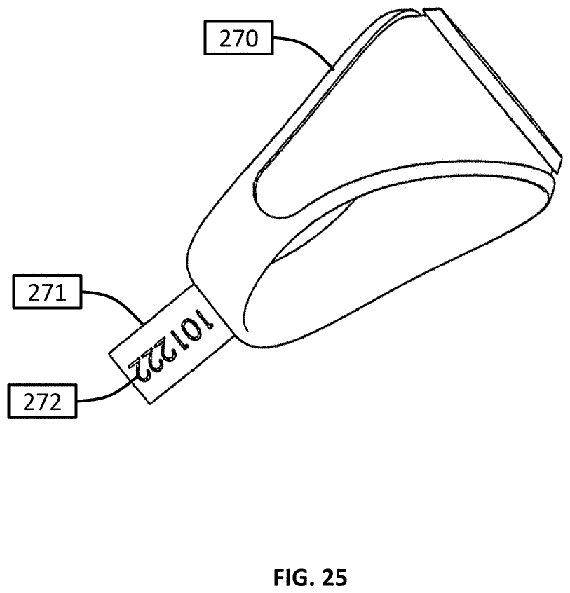

FIG. 25 illustrates the class ring core [270] and the sprue appendage [271]. The sprue has numerical values which are also 3D geometry generated on the sprue geometry [272] which were generated by the digital traveler system modular controller [163] processing steps. In this figure, the digital traveler geometry would be output by a 3D printer device enabling the easy identification of an individual order within a larger array of individual orders [266] output by the system. The Digital Traveler geometry is an update to the base 3D CAD model performed by the system in a manner that may occur before nesting and stacking operations such that the geometry is included in the analysis of the nesting and stacking operation resulting in nested batches of 3D CAD models.

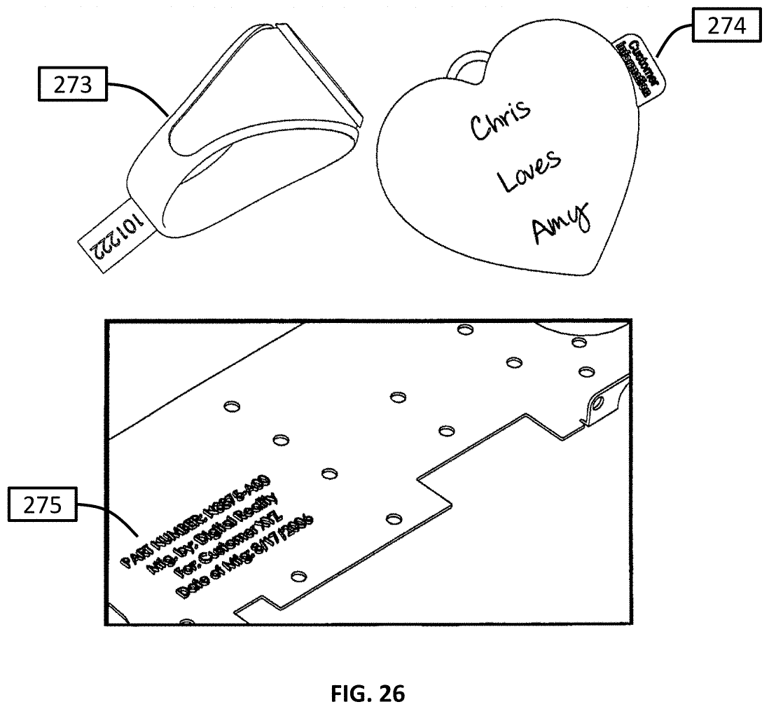

FIG. 26 illustrates several versions of digital traveler geometry, methods and locations including; the class ring sprue geometry [273], an appendage [274] or direct part marking [275]. The Digital Traveler geometry in each case enabling part tracking and identification information to be generated dynamically by the system modular controllers during system workflow performed to prepare production.

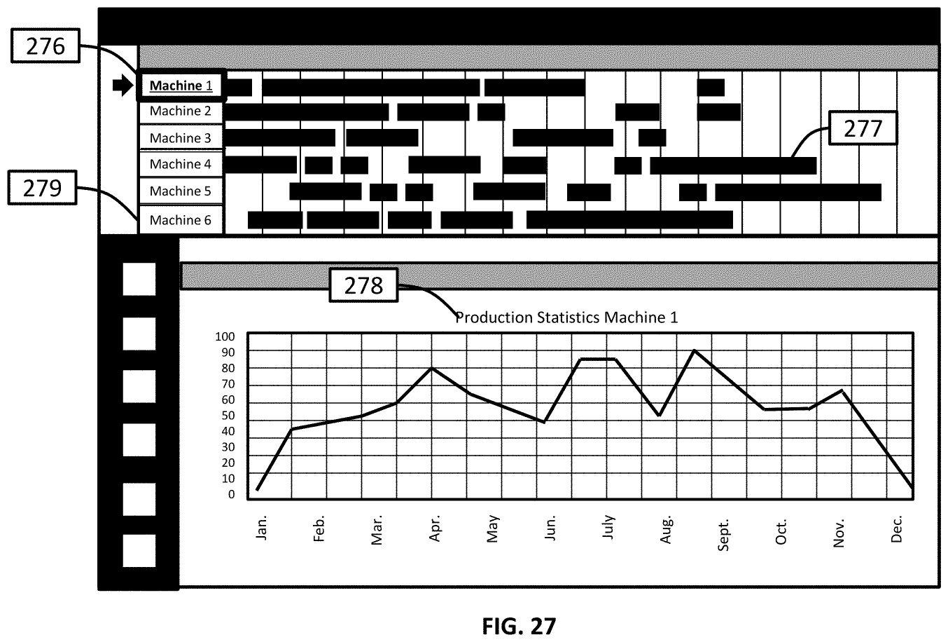

FIG. 27 illustrates an exemplary production scheduling interface of the invention. Each Additive Manufacturing device [276] indexed within and representing a production resource available to the system is presented, along with its production schedule. Each additional machine in the production resource list is also reflected in the system such as machine 6[279]. Each black bar represents a production scheduled bath job of 3D CAD models prepared and arranged for production by the system in a nesting operation, in a sequence of jobs and assigned to each Additive Manufacturing device [277]. Each job bar represents a “tray” file of properly nested or “packed” arrangements of 3D CAD Models. The chart or graph [278] represents production utilization statistics for each machine such as machine number 1 [276] which is shown selected to present the statistics for the particular AM machine selected. The production system including production scheduling adapted to perform in a manner particularly useful for additive manufacturing.

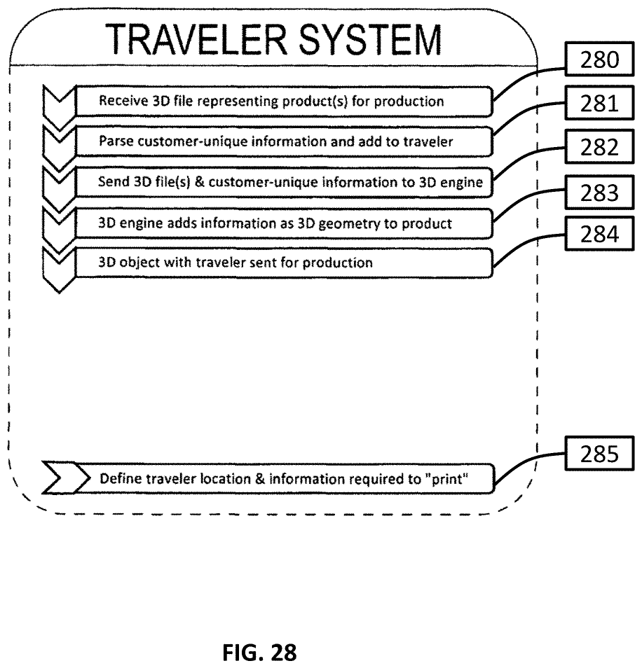

FIG. 28 illustrates system processing steps performed by the modular traveler controller system or Digital Traveler controller and performing processing steps for; receiving a production request for processing a 3D CAD Model during a production subroutine routing [280], parsing production criteria required to be converted to geometry related to the unique order [281], submitting a request from the controller to a 3D CAD Engine to generate the data as geometry [282], waiting for the 3D Kernel or engine to generate the geometry [283] and update the 3D CAD Model file with the geometry and routing the production command to the next processing step in the production subroutine [284]. The modular controller also provides an enables traveler definition as geometry to be defined in an interface including traveler geometry, location relative to the 3D CAD Model and what information to be converted to geometry [285].

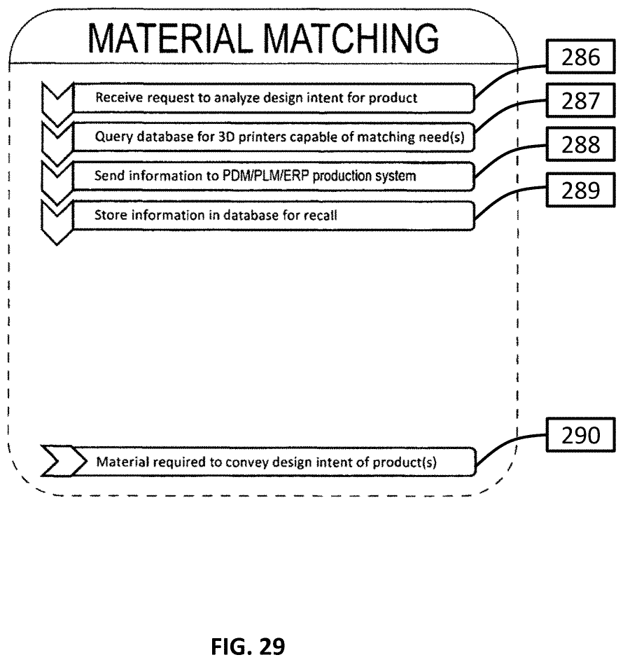

FIG. 29 illustrates system processing steps performed by the modular material matching controller including; receiving processing requests from the production controller to analyze the design intent of a 3D CAD model and its corresponding production criteria information [286], parsing the database of indexed production resources for 3D printer devices meeting the production criteria [287], sending the 3D printer device information for 3D printer devices meeting the production criteria to the system production scheduling controller [288] and storing information in the database for recall [289]. The modular controller also having and providing a commercial user with an interface to define material criteria, in a manner, associating it with 3D printer devices indexed within the system and therefore design intent [290]. For example; a Wax Solid-Scape 3D printer device may be associated with a material selection by a consumer user selecting gold or sterling silver where the wax is needed to cast the gold or silver.

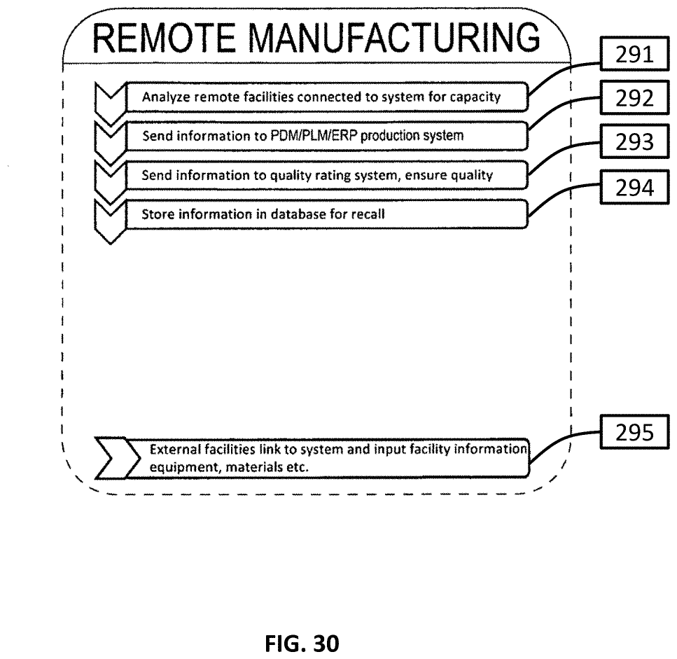

FIG. 30 illustrates system processing steps performed by the modular remote manufacturing controller including; analyzing remote manufacturing facilities and capacity indexed within the system for capabilities to produce the 3D CAD Model remotely [291] and providing the analysis information to the production scheduling system controller [292], sending requests to the quality rating system subroutine modular controller to compare past production event quality to database characterization for the remote facility selected [293] and storing information in the database for recall by the system. The remote manufacturing controller module also provides an interface for external production facilities to create a profile within the system and to input facility production capabilities, equipment, materials, and quantities of equipment [295]. The production capabilities of the remote facilities input by remote commercial user manufacturers being made available to the systems production scheduling controller for production scheduling activities performed by the system. and 19 depict network diagrams of embodiments of the present system.

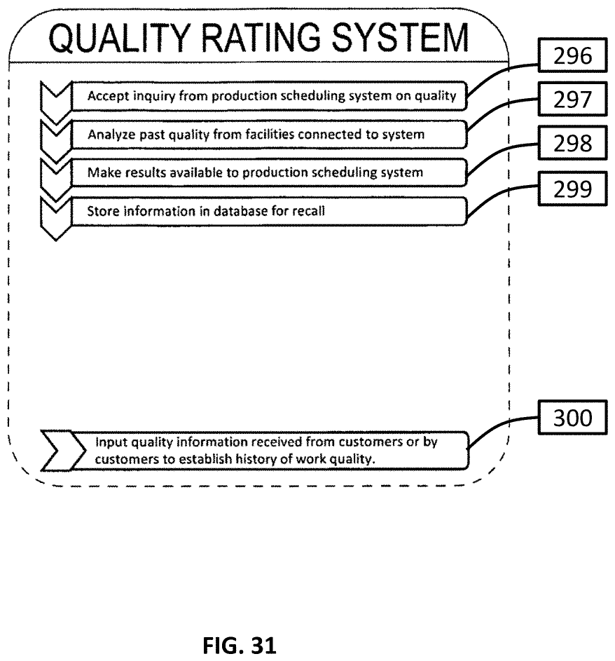

FIG. 31 illustrates system processing steps performed by the modular quality rating controller including; receiving inquiry requests from the production scheduling controller for quality information [296] where the quality rating information is comprised of characterized ratings based on past production jobs, analyzing the past quality information for reputation data based on remote factories connected to the system [297] and making the resulting information available to the production scheduling system [298] during order processing as well as storing information in the database related to the quality metrics [299]. The system also providing an interface for customers to input quality ratings based on orders placed by the users to establish a past work quality rating within the system [300].

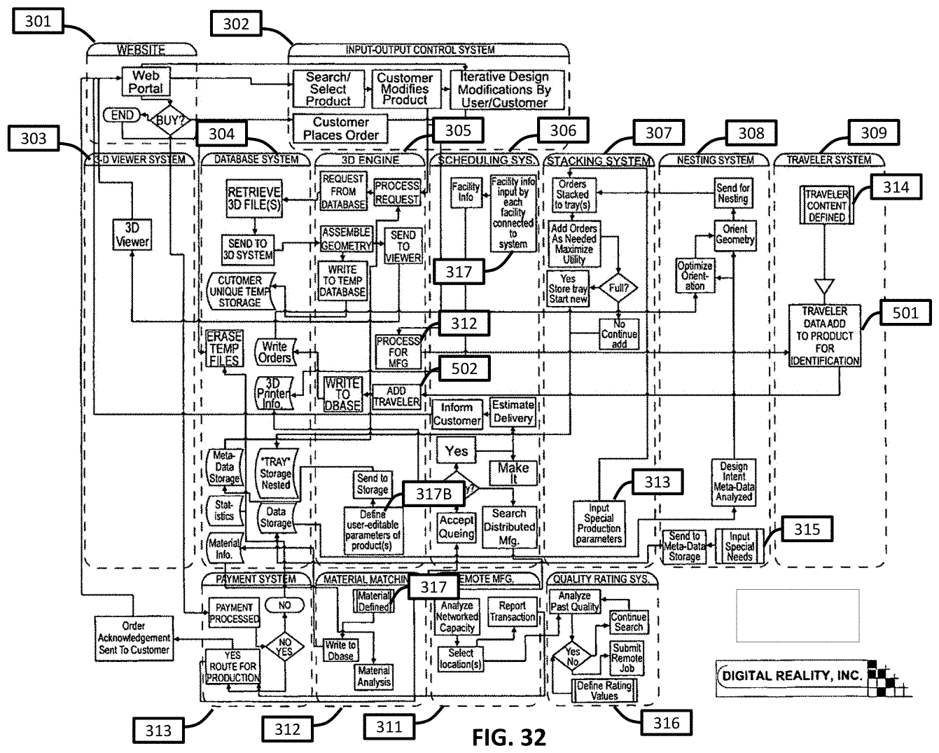

FIG. 32 illustrates one embodiment of the overall integrated workflow of the Made-To-Order portion and the Digital Manufacturing Enterprise portion of the system. The figures demonstrates that the system is comprised of modular controllers including a website modular controller, a I/O modular controller [302], a 3D web viewer controller [303], a database system controller [304], a 3D CAD Kernel or Engine [305], a production scheduling system controller [306], a stacking system controller [307]. A nesting system controller [308], a traveler geometry generation controller [309], a quality rating system modular controller [310], a remote manufacturing system controller [311], a material matching system controller [312] and a payment gateway system [313]. An Interface for defining digital travelers [314] and processing steps to generate traveler geometry [501], an interface to input special needs for the functionality of the nesting system [315], a method to input quality ratings [316], q method for the commercial user to define production resources, printers, materials and system functionality [317], define co-design constraints [317B] and define materials for design intent [317A]. The figure also demonstrates the general arrangement of the workflow describing the generation of 3D CAD Models or copies of 3D CAD Models via a website and subsequent system processing steps for manufacturing that begin with a process for manufacturing subroutine that begins the production planning, and execution portions of the workflow of the invention.

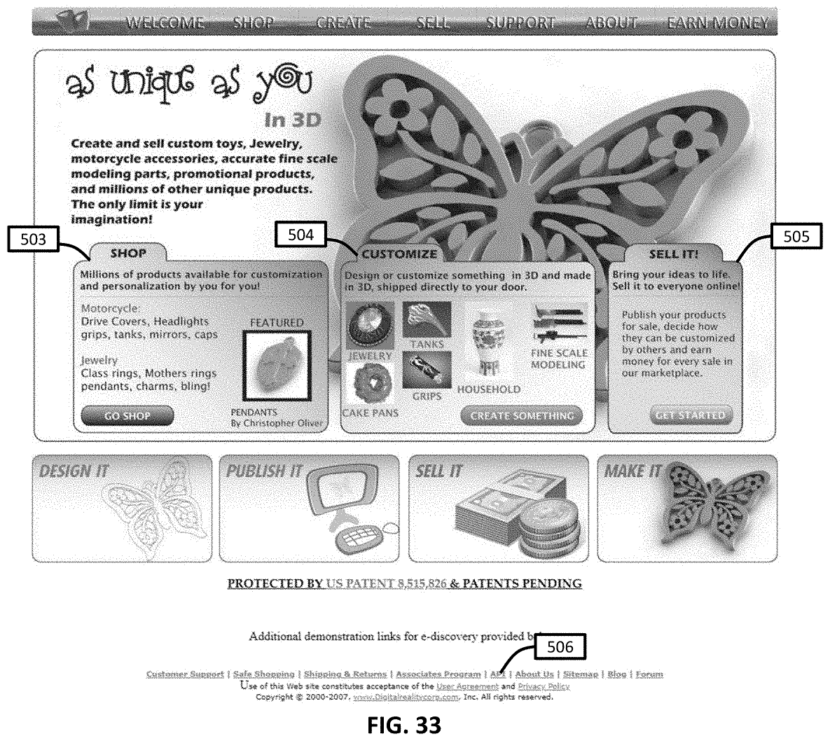

FIG. 33 illustrates an exemplary deployment of the invention including a website, displayed on a domain operated by a commercial user, offering by e-commerce, generated, at least in part, by the system controllers to retail customers [301] enabling retail customers to shop [503] for products within the e-commerce website portion. The figure additionally illustrates the ability to utilize the co-design interface within the system [504] to customize products before purchase. The figure additionally illustrates the commercial user enabling 3rd party contributors to upload and sell products in the system through the website [505] where 3rd party users may even be enabled to receive a sales commission [155] when the 3D CAD Models are sold and produced by the commercial user utilizing the invention. The illustration also demonstrates the ability for 3rd party users to upload and configure base 3D CAD Models for Co-Design [505] of 3D CAD Models and the commercial sale of products based in an ecommerce store based on the 3D CAD models uploaded, received, and stored in the system and produced at least in part by Additive Manufacturing through the workflow of the invention and additive manufacturing. The illustration further demonstrates the availability of an API or application programming interface [506] for enabling 3rd party integration into the invention.

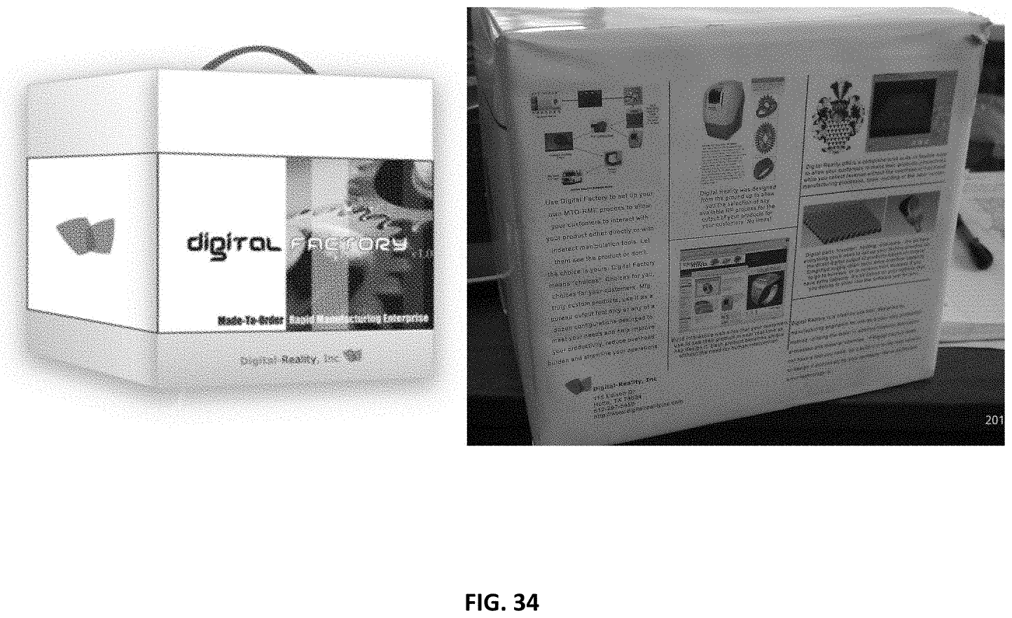

FIG. 34 illustrates a physical exemplary embodiment of the invention as a commercial software system entitled Digital Factory and the Made-To-Order Digital Manufacturing Enterprise statement on the software box and representing a computerized system for both Co-Design AND Digital Workflow Management.

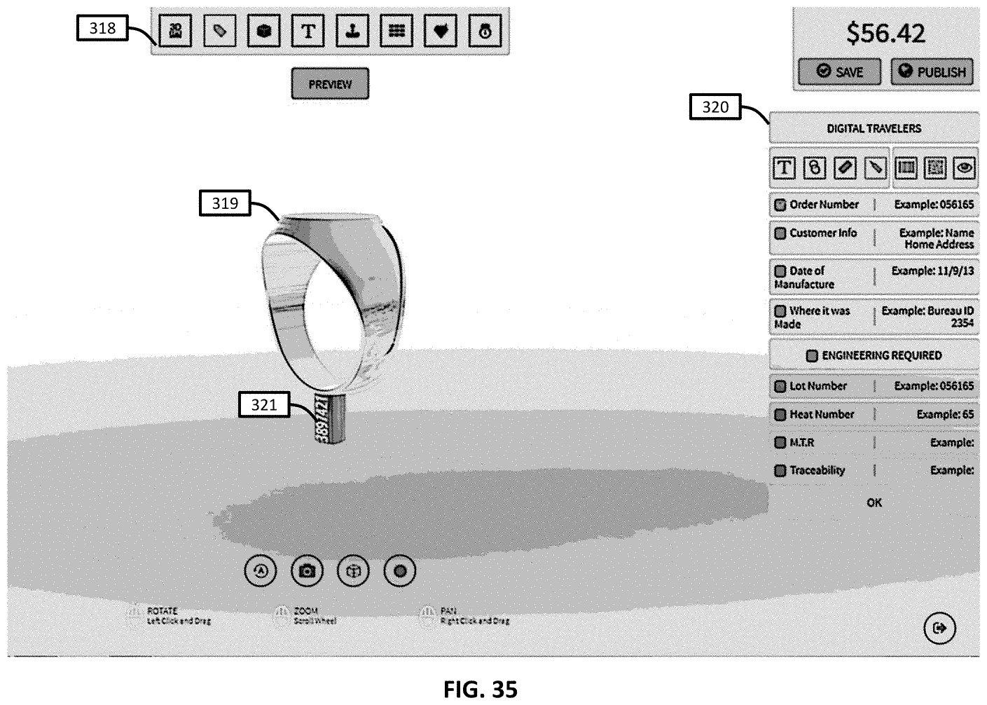

FIG. 35 illustrates an exemplary interface for defining and configuring a digital traveler feature for a base 3D CAD model uploaded to the system, in this case, a casting sprue containing digital traveler geometry [321]. The traveler functionality performed by the traveler modular controller [163] performing the processing steps demonstrated in FIG. 28. Note that the traveler functionality operates much like the co-design constraint system however; the interface is intended to be provided to the commercial user and not to the consumer user through the commercial user interface [156] for performing the traveler functionality [309]. The interface [314] enables the commercial user to configure traveler content for part tracking and identification.

FIG. 36 illustrates the system illustrated in FIG. 32 as deployed on general computing hardware and performing additive manufacturing workflow for a fleet of additive manufacturing machines defined and indexed in the system [254] by the commercial user and demonstrating the expandable capacity of the system for providing a flexible production system comprising the invention [325] and Additive Manufacturing production hardware exemplified where several of the illustrated 3D printer devices are specified as a metal AM printer [322], a wax printer [323] and a plastic printer [324] and or multiple discrete machined coupled or available to and indexed in the system representing production resources. The system therefore capable of using any existing or future additive manufacturing hardware since all additive manufacturing 3D printer devices use 3D CAD Models for input.

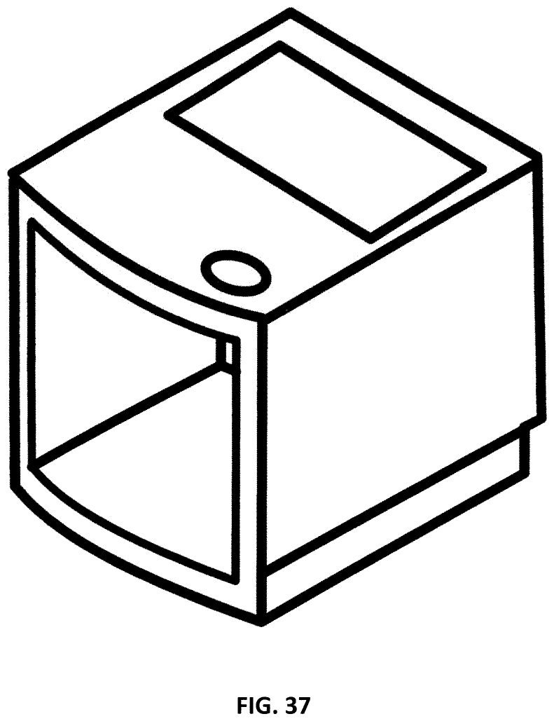

FIG. 37 illustrates an exemplary additive manufacturing printer device.

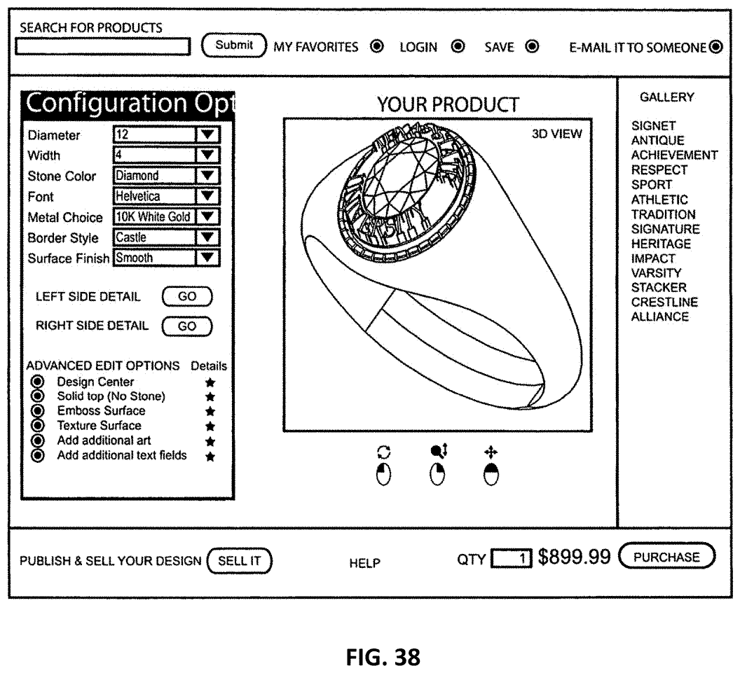

FIG. 38 illustrates the consumer user version of the co-design interface used within a website within an e-commerce session to co-design an exemplary class ring. The commercial user interface demonstrated in FIG. 2 is the commercial user version of FIG. 38.

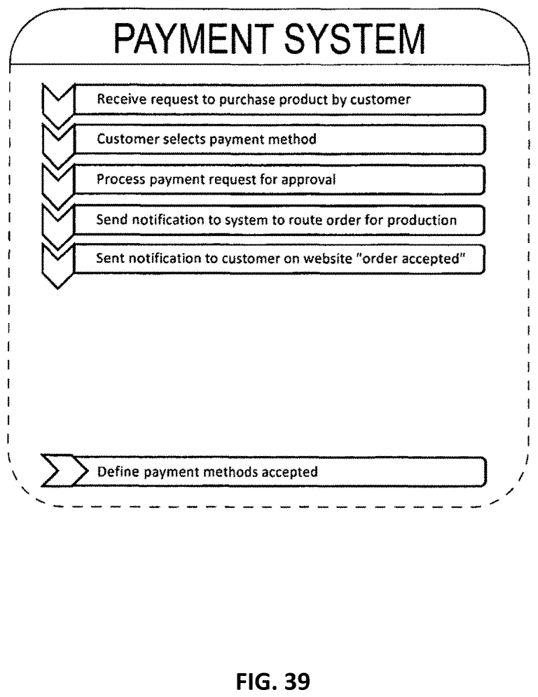

FIG. 39 illustrates a payment processing gateway for performing commonly understood payment processing steps prior to allowing the 3D CAD Model(s) to be compiled by the Co-Design system and transferred to the order aggregation device of the digital MES portion of the system for production workflow operations performed by the system. The process started during a process for manufacturing subroutine [312].

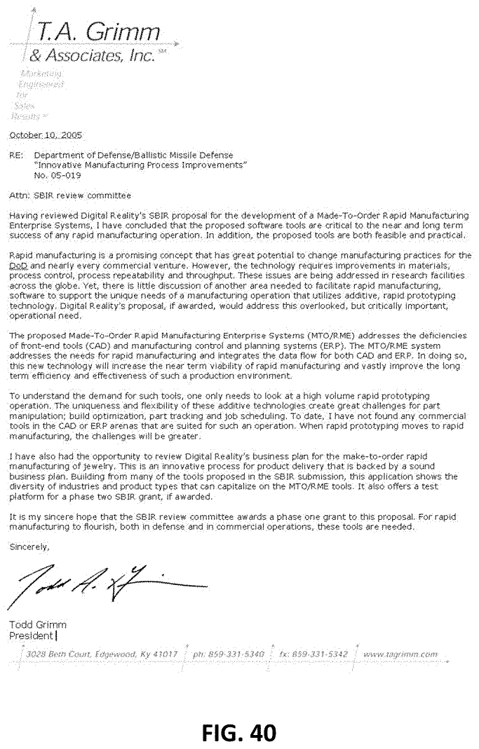

FIG. 40 illustrates a letter from Additive Manufacturing Expert Todd Grim supporting the development of the invention to the United States Military.

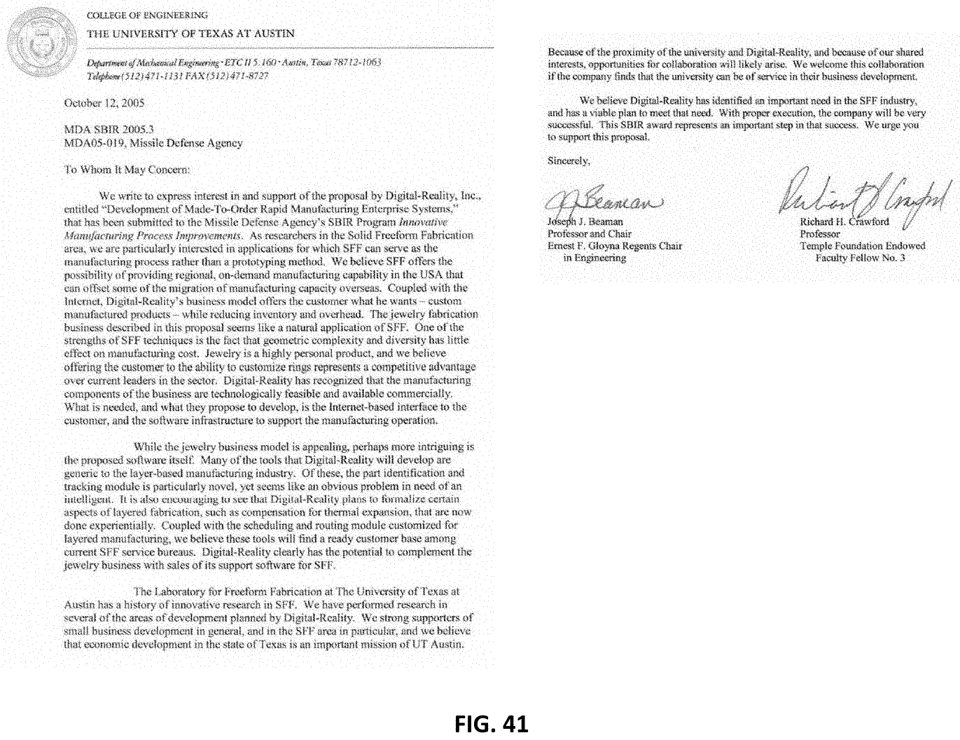

FIG. 41 illustrates a support letter from Additive Manufacturing Experts Dr. Joe Beaman and Dr. Richard Crawford supporting the development of the system to the United States Military.

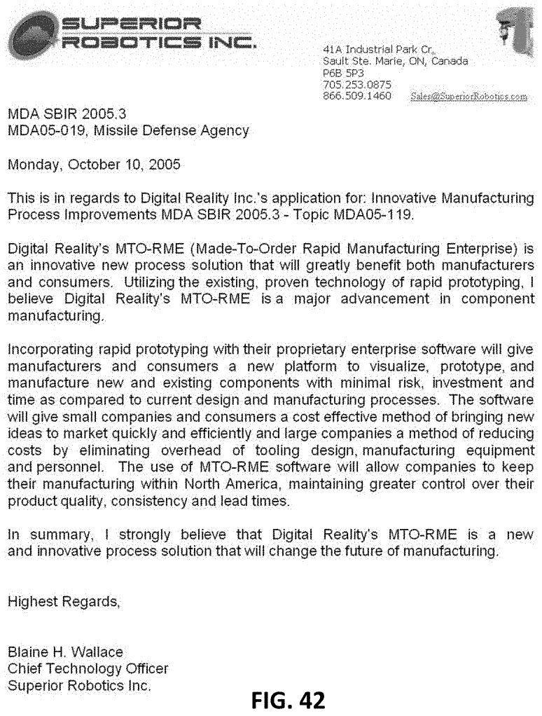

FIG. 42 illustrates a support letter from software and Manufacturing Experts Blain Wallace supporting the development of the system to the United States Military.

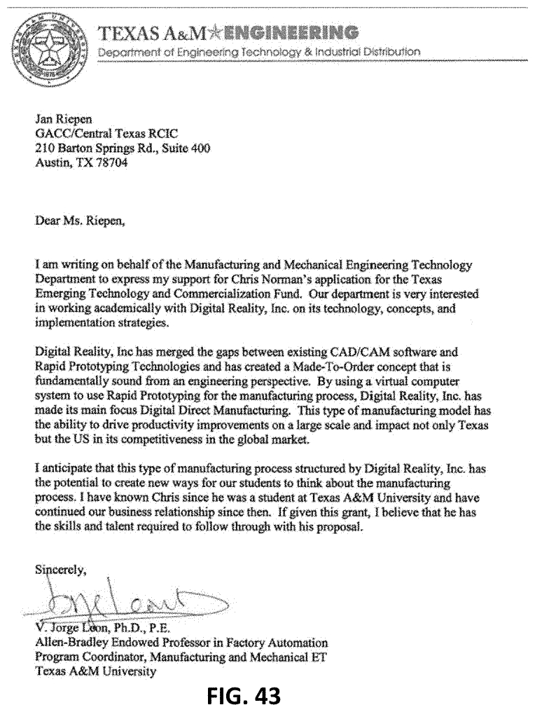

FIG. 43 illustrates a support letter from Dr. V. Jorge Leon, Manufacturing Engineering department head at Texas A&M University supporting the development of the system to the Texas Emerging Technology fund.

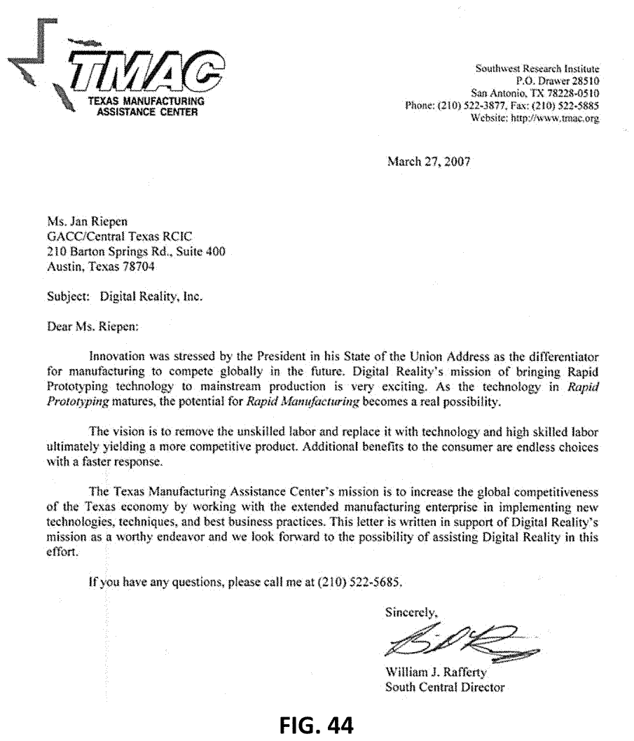

FIG. 44 illustrates a support letter from Jan Ripen, Texas Manufacturing Assistance Center supporting the development of the system to the Texas Emerging Technology fund.

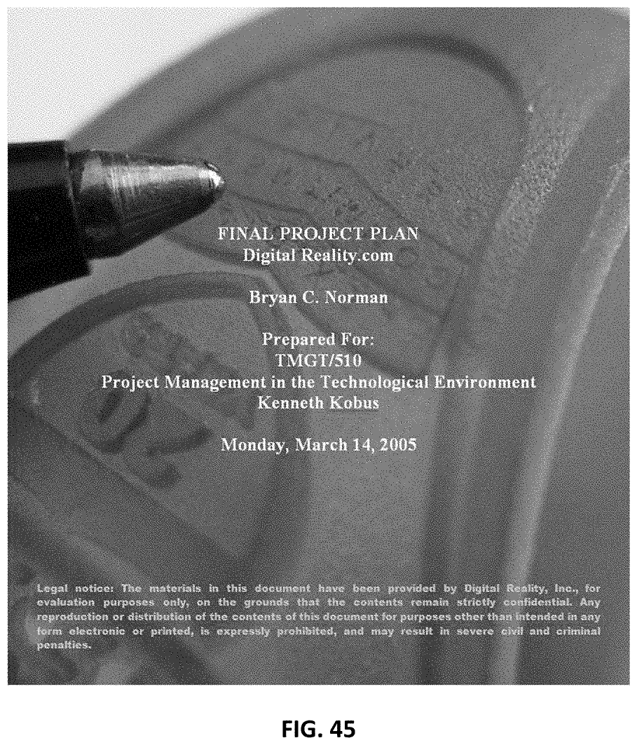

FIG. 45 illustrates a graded college paper received by the applicant of which an A was received for a business management class during an MBA program for the development of the invention provided with a legal notice for confidentiality.

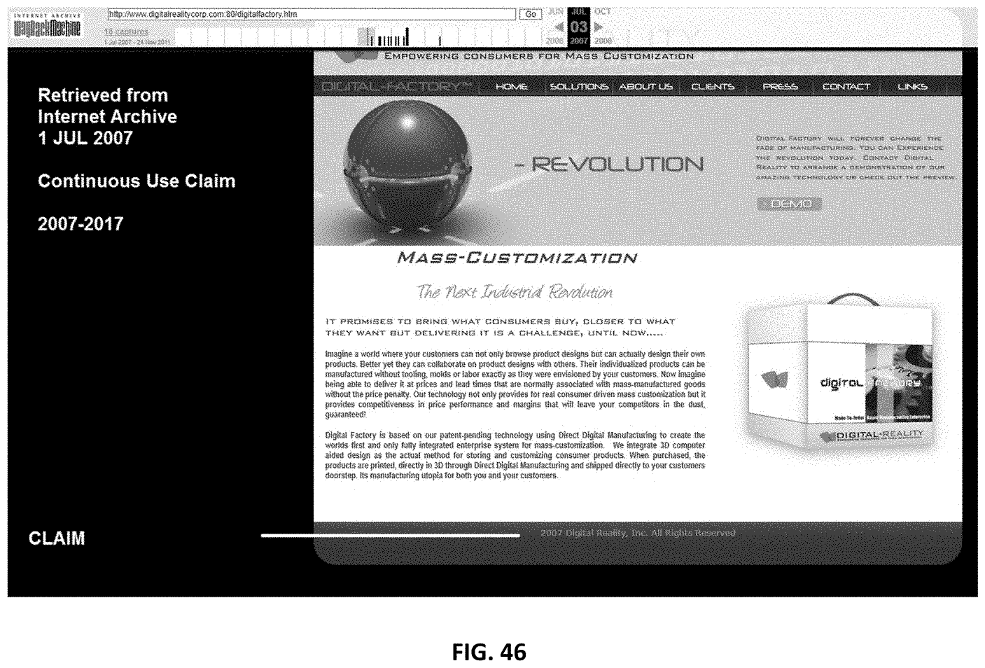

FIG. 46 illustrates the commercial nature of the invention embodied as system entitled Digital Factory displayed on an internet domain www.digitalrealitycorp.com as retrieved from the way back machine internet archive.

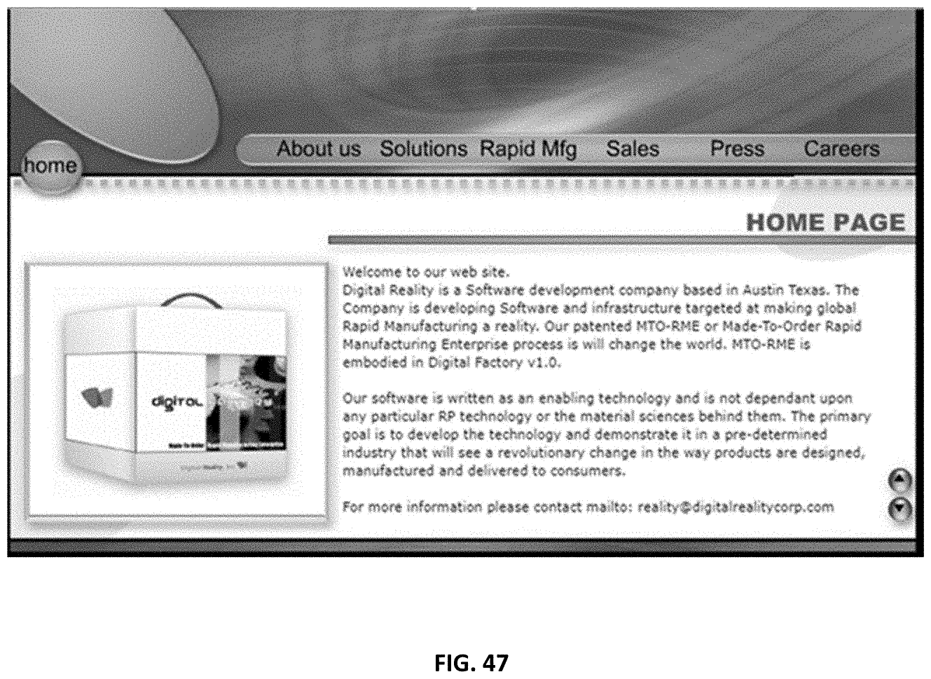

FIG. 47 illustrates the invention embodied as commercial software system entitled Digital Factory displayed at the domain www.digitalrealitycorp.com.

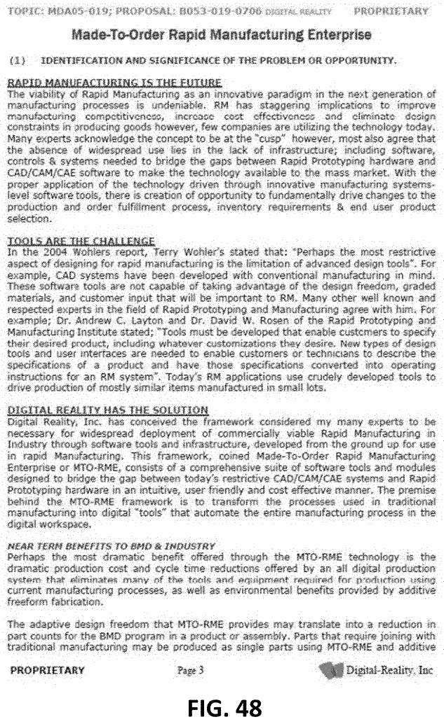

FIG. 48 illustrates an exemplary page of the proposal submitted to the United States Military for the development of invention under Small Business Innovation Research Grant Proposal MDA05-019 B053-019-0706 circa 2005 and marked proprietary.

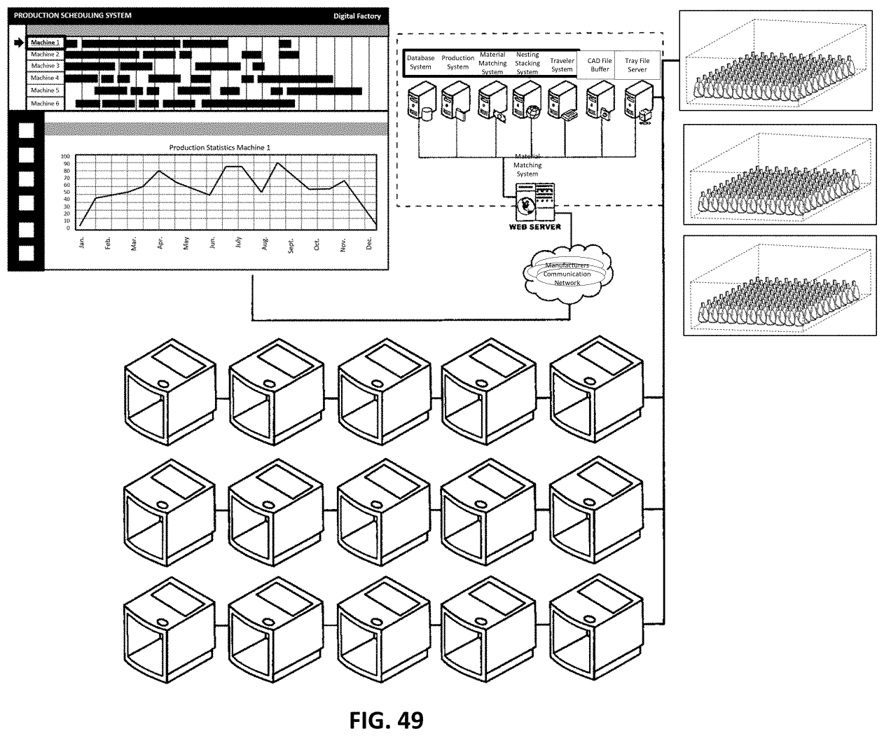

FIG. 49 illustrates an exemplary use of the production management and scheduling interface available to the commercial user for the Digital MES portion of the invention for managing the fleet of additive manufacturing machines indexed within the system and representing production resources available to the system for workflow management. The system generated tray files are queued for production by the fleet of machines available and indexed within the system. The figure demonstrates the computer system having a database system [304], a production scheduling system [306], a stacking [307] and nesting system [308], a traveler system [309], a cad model aggregation device, a tray file production queue device, several packed tray files of 3D CAD Models and a fleet of additive manufacturing devices. The manufacturing devices are indexed within the system [254] by the commercial user as well as the system operating parameters for the nesting system [259] and stacking system [265], parameters for the traveler system [285], the material matching system [290] and other configurable operating parameters.

In one embodiment the invention provides a method for optimizing Additive Manufacturing production resource utilization and enabling commercial opportunities thereof comprising; an Additive Manufacturing packing system comprised of software programming code arranged and configured to control general computing hardware and having at least one non-transitory computer-readable memory associated with the general computing hardware to dynamically: receive, by the packing system, a request to generate at least one tray file and data describing a batch of 3D CAD Model files, containing 3D Geometry, to be packed within the tray file; determine, by the Additive Manufacturing packing system, a packing plan solution for each 3D CAD Model file geometry received in the batch of 3D CAD Model files that optimizes utilization of a production resource according to the production criteria and bounding box or printable area of the production resource; re-orient, by the Additive Manufacturing packing system, each 3D CAD Model in the batch to form an optimized arrangement of the geometry described in each of the 3D CAD Model files based on the packing plan solution; compile, by the Additive Manufacturing packing system, the optimized arrangement into at least one tray file containing the data describing the geometry of the batch of 3D CAD Models received; and transfer or otherwise make available, by the nesting and stacking system, each compiled tray file for instructing, at least in part, an additive manufacturing production resource device to produce the geometry of the 3D CAD Model files within the tray file to do so; and Wherein the packing system is comprised of a nesting system controller, a packing system controller and at least one 3D CAD Kernel and; wherein the production criteria is at least one of; the printable area, the bounding box, and the production material specified for each; nesting area or bounding box of an AM printer device based on capacity constraints, delivery time or commercial user parameters and specifications; and wherein the orientation of each 3D CAD Model is altered by the at least one 3D Kernel or more 3D CAD Kernels associated with the system and an analysis of the geometry of the 3D CAD Model by the 3D CAD Kernel; and wherein the packing solution ensures that the available print area or production volume is efficiently and completely utilized; and wherein the compiled tray files are written to a database or file system for tray file storage in the production queue.

In one embodiment, the method additionally comprises one or more 3D CAD kernels and arranged to utilize the 3D CAD kernels to parse and analyze 3D CAD model geometry for determining a packing plan for batches of 3D CAD models fitting within the printable area or bounding box of a production resource.

In one embodiment, the method is additionally configured to enable; a commercial user to communicate with the additive Manufacturing nesting and stacking subsystems to establish a user profile within the system; and configured to enable the commercial user to input and define special production parameters, resources and production criteria for the additive Manufacturing nesting and staking subsystems.

In one embodiment, the method is additionally configured to use at least one of; special production parameters received from a commercial user and production criteria comprising at least one of; the available build envelope of a particular AM production resource, the available number of identical AM production resources available, the estimated time required to build a given batch size (quantity), the geospatial location of a particular AM production resource and forecasts to dynamically; Analyze, by the system, current order volumes and forecasts; determine, by the system, at least one alternative production plan that re-organizes the batches of 3D CAD models in order to; determine, by the system, a production plan that maximize production of a given production resource by packing as many 3D CAD Models from a batch into the build envelope such that the AM Production resource is efficiently and completely utilized; or determine, by the system, an alternative production plan; re-organize, by the system, the batches to manage the trade-off between capacity and delivery lead-time time; and generate, by the nesting and stacking system, an arrangement of the alternate batches of 3D CAD models geometry that optimizes utilization of a production resource according to the production criteria; and compile, by the nesting and stacking system, the alternate optimized arrangement into a tray file containing the data describing the geometry of the batch of 3D CAD Models.

In one embodiment, the method is additionally arranged to compute multiple solutions to the packing problem and selecting the optimum solution based on capacity constraints and or throughput.

In one embodiment, the method is additionally configured to determine, using the 3D CAD Kernel, if a particular part will fit within the printable area or bounding box of an AM production device.

In one embodiment, the method is additionally configured to determine an alternate packing arrangement based on the quantity of duplicate copies of a single CAD model requested.

In one embodiment, the method is additionally configured to perform the operation using client-side computing resources.

In one embodiment, the method is additionally configured to coordinate packing and scheduling activities with a Production system controller arranged for Additive Manufacturing production resource optimization of nested or “packed” arrangements of 3D CAD Models in tray files.

In one embodiment, the method is additionally configured to utilize an API for performance of the packing system operations.

In one embodiment, the invention provides a system for optimizing Additive Manufacturing production resource utilization and enabling commercial opportunities thereof comprising;

In one embodiment, the invention provides an Additive Manufacturing packing system comprised of software programming code arranged and configured to control general computing hardware and having at least one non-transitory computer-readable memory associated with the general computing hardware to dynamically:

In one embodiment, the system is arranged to receive, by the packing system, a request to generate at least one tray file and data describing a batch of 3D CAD Model files, containing 3D Geometry, to be packed within the tray file;

In one embodiment, the system is arranged to determine, by the Additive Manufacturing packing system, a packing plan solution for each 3D CAD Model file geometry received in the batch of 3D CAD Model files that optimizes utilization of a production resource according to the production criteria and bounding box or printable area of the production resource;

In one embodiment, the system is arranged to re-orient, by the Additive Manufacturing packing system, each 3D CAD Model in the batch to form an optimized arrangement of the geometry described in each of the 3D CAD Model files based on the packing plan solution;

In one embodiment, the system is arranged to compile, by the Additive Manufacturing packing system, the optimized arrangement into at least one tray file containing the data describing the geometry of the batch of 3D CAD Models received; and

In one embodiment, the system is arranged to transfer or otherwise make available, by the nesting and stacking system, each compiled tray file for instructing, at least in part, an additive manufacturing production resource device to produce the geometry of the 3D CAD Model files within the tray file to do so; and

In one embodiment, the packing system is comprised of a nesting system controller, a packing system controller and at least one 3D CAD Kernel and;

In one embodiment of the system, the production criteria is at least one of; the printable area, the bounding box, and the production material specified for each; nesting area or bounding box of an AM printer device based on capacity constraints, delivery time or commercial user parameters and specifications; and

In one embodiment of the system, the orientation of each 3D CAD Model is altered by the at least one 3D Kernel or more 3D CAD Kernels associated with the system and an analysis of the geometry of the 3D CAD Model by the 3D CAD Kernel; and

wherein the packing solution ensures that the available print area or production volume is efficiently and completely utilized; and wherein the compiled tray files are written to a database or file system for tray file storage in the production queue.

In one embodiment, the system is additionally comprising one or more 3D CAD kernels and arranged to utilize the 3D CAD kernels to parse and analyze 3D CAD model geometry for determining a packing plan for batches of 3D CAD models fitting within the printable area or bounding box of a production resource.

In one embodiment, the system is additionally configured to enable; a commercial user to communicate with the additive Manufacturing nesting and stacking subsystems to establish a user profile within the system; and configured to enable the commercial user to input and define special production parameters, resources and production criteria for the additive Manufacturing nesting and staking subsystems.

In one embodiment, the system is additionally configured to use at least one of; special production parameters received from a commercial user and production criteria comprising at least one of; the available build envelope of a particular AM production resource, the available number of identical AM production resources available, the estimated time required to build a given batch size (quantity), the geospatial location of a particular AM production resource and forecasts to dynamically; Analyze, by the system, current order volumes and forecasts; determine, by the system, at least one alternative production plan that re-organizes the batches of 3D CAD models in order to; determine, by the system, a production plan that maximize production of a given production resource by packing as many 3D CAD Models from a batch into the build envelope such that the AM Production resource is efficiently and completely utilized; or determine, by the system, an alternative production plan; re-organize, by the system, the batches to manage the trade-off between capacity and delivery lead-time time; and generate, by the nesting and stacking system, an arrangement of the alternate batches of 3D CAD models geometry that optimizes utilization of a production resource according to the production criteria; and compile, by the nesting and stacking system, the alternate optimized arrangement into a tray file containing the data describing the geometry of the batch of 3D CAD Models.

In one embodiment, the system is additionally arranged for computing multiple solutions to the packing problem and selecting the optimum solution based on capacity constraints and or throughput.

In one embodiment, the system is additionally configured to determine, using the 3D CAD Kernel, if a particular part will fit within the printable area or bounding box of an AM production device.

In one embodiment, the system is additionally configured to determine an alternate packing arrangement based on the quantity of duplicate copies of a single CAD model requested.

In one embodiment, the system is additionally configured to perform the operation using client-side computing resources.

In one embodiment, the system is additionally configured to coordinate packing and scheduling activities with a Production system controller arranged for Additive Manufacturing production resource optimization of nested or “packed” arrangements of 3D CAD Models in tray files.

In one embodiment, the system is additionally configured to utilize an API for performance of the packing system operations.

In the foregoing specification, and exemplary embodiments of the invention, e.g. a Digital MES Additive Manufacturing Workflow Management System have been described as having an implementation providing utility for commercial Additive Manufacturing. Each portion of the invention comprising modular controllers arranged to control general computing hardware in the performance of the various embodiments described herein including by means of a distributed computing system where each subsystem and or controller may be operated independently of one another or in conjunction with one another in performance of the methods described herein. Furthermore, the preceding specification have described with reference to specific embodiments thereof. However, various modifications and changes may be made thereto without departing from the broader spirit and scope of the invention. The specifications and drawings are, accordingly, to be regarded in an illustrative sense rather than a restrictive sense.

1. A method for optimizing Additive Manufacturing production resource utilization and enabling commercial opportunities thereof comprising;
a. an Additive Manufacturing packing system comprised of software programming code arranged and configured to control general computing hardware and having at least one non-transitory computer-readable memory associated with the general computing hardware to dynamically:
b. receive, by the packing system, a request to generate at least one tray file and data describing a batch of 3D CAD Model files, containing 3D Geometry, to be packed within the tray file;
c. determine, by the Additive Manufacturing packing system, a packing plan solution for each 3D CAD Model file geometry received in the batch of 3D CAD Model files that optimizes utilization of a production resource according to the production criteria and bounding box or printable area of the production resource;
d. re-orient, by the Additive Manufacturing packing system, each 3D CAD Model in the batch to form an optimized arrangement of the geometry described in each of the 3D CAD Model files based on the packing plan solution;
e. compile, by the Additive Manufacturing packing system, the optimized arrangement into at least one tray file containing the data describing the geometry of the batch of 3D CAD Models received; and
f. transfer or otherwise make available, by the nesting and stacking system, each compiled tray file for instructing, at least in part, an additive manufacturing production resource device to produce the geometry of the 3D CAD Model files within the tray file to do so; and
i. Wherein the packing system is comprised of a nesting system controller, a packing system controller and at least one 3D CAD Kernel and;
ii. wherein the production criteria is at least one of; the printable area, the bounding box, and the production material specified for each; nesting area or bounding box of an AM printer device based on capacity constraints, delivery time or commercial user parameters and specifications; and
iii. wherein the orientation of each 3D CAD Model is altered by the at least one 3D Kernel or more 3D CAD Kernels associated with the system and an analysis of the geometry of the 3D CAD Model by the 3D CAD Kernel; and
iv. wherein the packing solution ensures that the available print area or production volume is efficiently and completely utilized; and
v. wherein the compiled tray files are written to a database or file system for tray file storage in the production queue.

2. The method of claim 1 additionally comprising one or more 3D CAD kernels and arranged to utilize the 3D CAD kernels to parse and analyze 3D CAD model geometry for determining a packing plan for batches of 3D CAD models fitting within the printable area or bounding box of a production resource.

3. The method of claim 1 additionally configured to enable;
a. a commercial user to communicate with the additive Manufacturing nesting and stacking subsystems to establish a user profile within the system; and
b. configured to enable the commercial user to input and define special production parameters, resources and production criteria for the additive Manufacturing nesting and staking subsystems.

4. The method of claim 1 additionally configured to use at least one of; special production parameters received from a commercial user and production criteria comprising at least one of; the available build envelope of a particular AM production resource, the available number of identical AM production resources available, the estimated time required to build a given batch size (quantity), the geospatial location of a particular AM production resource and forecasts to dynamically;
a. Analyze, by the system, current order volumes and forecasts;
b. determine, by the system, at least one alternative production plan that re-organizes the batches of 3D CAD models in order to;
i. determine, by the system, a production plan that maximize production of a given production resource by packing as many 3D CAD Models from a batch into the build envelope such that the AM Production resource is efficiently and completely utilized; or
ii. determine, by the system, an alternative production plan;
iii. re-organize, by the system, the batches to manage the trade-off between capacity and delivery lead-time time; and
iv. generate, by the nesting and stacking system, an arrangement of the alternate batches of 3D CAD models geometry that optimizes utilization of a production resource according to the production criteria; and
v. compile, by the nesting and stacking system, the alternate optimized arrangement into a tray file containing the data describing the geometry of the batch of 3D CAD Models.

5. The method of claim 1 additionally computing multiple solutions to the packing problem and selecting the optimum solution based on capacity constraints and or throughput.

6. The method of claim 1 additionally configured to determine, using the 3D CAD Kernel, if a particular part will fit within the printable area or bounding box of an AM production device.

7. The method of claim 1 additionally configured to determine an alternate packing arrangement based on the quantity of duplicate copies of a single CAD model requested.

8. The Method of claim 1 additionally configured to perform the operation using client-side computing resources.

9. The method of claim 1 additionally configured to coordinate packing and scheduling activities with a Production system controller arranged for Additive Manufacturing production resource optimization of nested or “packed” arrangements of 3D CAD Models in tray files.

10. The method of claim 1 additionally configured to utilize an API for performance of the packing system operations.

11. A system for optimizing Additive Manufacturing production resource utilization and enabling commercial opportunities thereof comprising;
a. an Additive Manufacturing packing system comprised of software programming code arranged and configured to control general computing hardware and having at least one non-transitory computer-readable memory associated with the general computing hardware to dynamically:
b. receive, by the packing system, a request to generate at least one tray file and data describing a batch of 3D CAD Model files, containing 3D Geometry, to be packed within the tray file;
c. determine, by the Additive Manufacturing packing system, a packing plan solution for each 3D CAD Model file geometry received in the batch of 3D CAD Model files that optimizes utilization of a production resource according to the production criteria and bounding box or printable area of the production resource;
d. re-orient, by the Additive Manufacturing packing system, each 3D CAD Model in the batch to form an optimized arrangement of the geometry described in each of the 3D CAD Model files based on the packing plan solution;
e. compile, by the Additive Manufacturing packing system, the optimized arrangement into at least one tray file containing the data describing the geometry of the batch of 3D CAD Models received; and
f. transfer or otherwise make available, by the nesting and stacking system, each compiled tray file for instructing, at least in part, an additive manufacturing production resource device to produce the geometry of the 3D CAD Model files within the tray file to do so; and
i. Wherein the packing system is comprised of a nesting system controller, a packing system controller and at least one 3D CAD Kernel and;
ii. wherein the production criteria is at least one of; the printable area, the bounding box, and the production material specified for each; nesting area or bounding box of an AM printer device based on capacity constraints, delivery time or commercial user parameters and specifications; and
iii. wherein the orientation of each 3D CAD Model is altered by the at least one 3D Kernel or more 3D CAD Kernels associated with the system and an analysis of the geometry of the 3D CAD Model by the 3D CAD Kernel; and
iv. wherein the packing solution ensures that the available print area or production volume is efficiently and completely utilized; and
v. wherein the compiled tray files are written to a database or file system for tray file storage in the production queue.

12. The system of claim 11 additionally comprising one or more 3D CAD kernels and arranged to utilize the 3D CAD kernels to parse and analyze 3D CAD model geometry for determining a packing plan for batches of 3D CAD models fitting within the printable area or bounding box of a production resource.

13. The system of claim 11 additionally configured to enable;
a. a commercial user to communicate with the additive Manufacturing nesting and stacking subsystems to establish a user profile within the system; and
b. configured to enable the commercial user to input and define special production parameters, resources and production criteria for the additive Manufacturing nesting and staking subsystems.

14. The system of claim 11 additionally configured to use at least one of; special production parameters received from a commercial user and production criteria comprising at least one of; the available build envelope of a particular AM production resource, the available number of identical AM production resources available, the estimated time required to build a given batch size (quantity), the geospatial location of a particular AM production resource and forecasts to dynamically;
a. Analyze, by the system, current order volumes and forecasts;
b. determine, by the system, at least one alternative production plan that re-organizes the batches of 3D CAD models to;
i. determine, by the system, a production plan that maximize production of a given production resource by packing as many 3D CAD Models from a batch into the build envelope such that the AM Production resource is efficiently and completely utilized; or
ii. determine, by the system, an alternative production plan;
iii. re-organize, by the system, the batches to manage the trade-off between capacity and delivery lead-time time; and
iv. generate, by the nesting and stacking system, an arrangement of the alternate batches of 3D CAD models geometry that optimizes utilization of a production resource according to the production criteria; and
v. compile, by the nesting and stacking system, the alternate optimized arrangement into a tray file containing the data describing the geometry of the batch of 3D CAD Models.

15. The system of claim 11 additionally computing multiple solutions to the packing problem and selecting the optimum solution based on capacity constraints and or throughput.

16. The system of claim 11 additionally configured to determine, using the 3D CAD Kernel, if a particular part will fit within the printable area or bounding box of an AM production device.

17. The system of claim 11 additionally configured to determine an alternate packing arrangement based on the quantity of duplicate copies of a single CAD model requested.

18. The system of claim 11 additionally configured to perform the operation using client-side computing resources.

19. The system of claim 11 additionally configured to coordinate packing and scheduling activities with a Production system controller arranged for Additive Manufacturing production resource optimization of nested or “packed” arrangements of 3D CAD Models in tray files.

20. The system of claim 11 additionally configured to utilize an API for performance of the packing system operations.
